(19) United States
(12) Patent Application Publication
(10) Pub. No.: US 2014/0222738 A1
(43) Pub. Date: Aug. 7, 2014

(54) Agent-Based Brain Model and Related Methods

(71) Applicants: Karen E. Joyce, Winston-Salem, NC (US); Paul J. Laurienti, Winston-Salem, NC (US); Satoru Hayasaka, Winston-Salem, NC (US)

(72) Inventors: Karen E. Joyce, Winston-Salem, NC (US); Paul J. Laurienti, Winston-Salem, NC (US); Satoru Hayasaka, Winston-Salem, NC (US)

(21) Appl. No.: 14/124,407

(22) PCT Filed: Jun. 8, 2012
(86) PCT No.: PCT/US12/41647

§ 371 Date: Apr. 7, 2014

Related U.S. Application Data
(60) Provisional application No. 61/495,112, filed on Jun. 9, 2011.

(51) Int. Cl. G06N 3/10; G06F 19/00

(52) U.S. Cl. CPC G06N 3/10; G06F 19/3437
USPC 706/13; 706/47

(57) ABSTRACT

An agent-based modeling system for predicting and/or analyzing brain behavior is provided. The system includes a computer processor configured to define nodes and edges that interconnect the nodes. The edges are defined by physiological interactions and/or anatomical connections. The computer processor further defines rules and/or model parameters that define a functional behavior of the nodes and edges. The computer processor assigns the nodes to respective brain regions, and the rules and/or model parameters are defined by observed physiological interaction of the nodes that are functionally and/or structurally connected by said edges of brain regions to thereby provide an agent-based brain model (ABBM) for predicting and/or analyzing brain behavior.

### RELATED APPLICATIONS

This application claims priority to U.S. Patent Application Ser. No. 61/495,112, filed Jun. 9, 2011, the disclosure of which is hereby incorporated by reference in its entirety.

### STATEMENT OF GOVERNMENT FUNDING

This invention was produced in part using funds from the Federal Government under Contract Nos. NS070917 and NS42568 awarded by the National Institute of Neurological Disorders and Stroke (NINDS). The Federal Government has certain rights in this invention.

### FIELD OF THE INVENTION

The present invention relates to agent-based models, and more particularly to agent-based models of a brain and related methods.

### BACKGROUND

Traditional practice in neuroscience has been to examine the brain in terms of isolated components extracted from images. However, more recent trends have moved towards examination of the entire brain in order to observe the complete topology and to capture emergent behavior not present at the component level. Additional techniques to understand brain interactions are needed.

### SUMMARY OF EMBODIMENTS OF THE INVENTION

In some embodiments, an agent-based modeling system for predicting and/or analyzing brain behavior is provided. The system includes a computer processor configured to define nodes and edges that interconnect the nodes. The edges are defined by physiological interactions and/or anatomical connections. The computer processor further defines rules and/or model parameters that define a functional behavior of the nodes and edges. The computer processor assigns the nodes to respective brain regions, and the rules and/or model parameters are defined by observed physiological interaction of the nodes that are functionally and/or structurally connected by said edges of brain regions to thereby provide an agent-based brain model (ABBM) for predicting and/or analyzing brain behavior.

In some embodiments, the rules and/or model parameters are determined by evolutionary algorithms. The rules and/or model parameters may be determined by genetic algorithms. The edges may be observed by an imaging modality. The imaging modality may be a structural MRI, functional MRI, EEG and/or MEG imaging modality. The edges may be observed by dissection. The brain regions may be mammalian brain regions.

In some embodiments, the computer processor assigns each of the nodes a state and updates the states responsive to the rules and/or model parameters. The computer processor may update the states using model parameters that are task and/or problem-based model parameters. The model parameters may be determined by optimization calculations including evolutionary algorithms, simulated annealing and/or hill climbing calculations. The computer processor may update the states using the model parameters so as to model emergent cognition, thought, consciousness, mimic human behavior and/or perform a task.

In some embodiments, the observed physiological interaction of the nodes that are functionally and/or structurally connected by the edges of brain regions are for a patient, the computer processor is further configured to provide a possible diagnoses for neurological diseases and/or conditions responsive to the nodes, edges, rules and/or model parameters for the patient. In some embodiments, the computer processor is further configured to determine a predicted prognosis for neurological diseases and/or conditions responsive to the nodes, edges, rules and/or model parameters for the patient.

In some embodiments, the computer processor is further configured to perform treatment tests that modify the model parameters and/or agent-based brain model based on a desired treatment and to determine a likely outcome of the desired treatment responsive to resulting changes in agent-based brain model outcomes.

In some embodiments, the edges comprise a weighting factor corresponding to a strength of interconnectivity between nodes.

In some embodiments, the nodes comprise a pair of first and second nodes. The first node has a first state with a first state value and the second node has second state with a second state value. The edges define a positive interconnectivity between the pair of first and second nodes when the first state value and the second state value of the first and second nodes are the same, and the edges define a negative interconnectivity between the pair of first and second nodes when the first state value and the second state value are different.

In some embodiments, the rules and/or model parameters include an internal motivation curve and environmental opportunity curve. The computer processor may be configured to output a behavior responsive to the internal motivation and environmental opportunity curves. The computer processor may configured to modify the internal motivation and environmental opportunity curves responsive to the behavior. In some embodiments, the internal motivation curve comprises a measurement of an internal need to perform a behavior or potential behavior, and the environmental opportunity curve comprises a measurement of an availability of a behavior, potential behavior, resource and/or other action. The internal motivation and environmental opportunity curves together define a benefit for performing each of a plurality of possible behaviors. In some embodiments, functional behavior comprises a plurality of behaviors, each of the plurality of behaviors comprising a weighted benefit corresponding to the internal motivation curve. A modification to the internal motivation and environmental opportunity curves may define the edges that interconnect the nodes.

In some embodiments, a method for providing an agent-based brain model for predicting and/or analyzing brain behavior is provided. The agent-based brain model includes nodes and edges that interconnect the nodes, rules and/or model parameters that define a functional behavior of the nodes and edges. The physiological interactions of ones of the nodes that are connected by respective ones of the edges is observed. A computer processor assigns the nodes to respective brain regions. A computer processor defines the edges responsive to physiological interactions and/or anatomical connections. The rules and/or model parameters are defined responsive to the observed physiological interactions and/or anatomical connections of the brain regions connected by the edges to thereby provide an agent-based brain model. Brain behavior may be predicted and/or analyzed using the agent-based brain model.

In some embodiments, a computer program product for providing an agent-based brain model predicting and/or analyzing brain behavior is provided. The agent-based brain model includes nodes and edges that interconnect the nodes, rules and/or model parameters that define a functional behavior of the nodes and edges. The computer program product includes a computer readable storage medium having computer readable program code embodied in the medium. The computer readable program code comprising includes computer readable program code configured to observe physiological interactions of the nodes that are connected by respective ones of the edges. Computer readable program code is configured to assign the nodes to respective brain regions. Computer readable program code is configured to define the edges responsive to physiological interactions and/or anatomical connections. Computer readable program code is configured to define the rules and/or model parameters responsive to the observed physiological interactions and/or anatomical connections of the brain regions connected by the edges to thereby provide an agent-based brain model for predicting and/or analyzing brain behavior.

### BRIEF DESCRIPTION OF THE DRAWINGS

The accompanying drawings, which are incorporated in and constitute a part of the specification, illustrate embodiments of the invention and, together with the description, serve to explain principles of the invention.

FIGS. 1A-1B are flowcharts of operations according to some embodiments of the present invention.

FIG. 1C is a schematic diagram illustrating a relationship between a solution space graph, an internal motivation graph and an environmental opportunity graph.

FIG. 1D is a schematic diagram illustrating operations according to some embodiments.

FIG. 2 is a schematic diagram of systems, methods and computer program products according to some embodiments of the present invention.

FIG. 3 are images illustrating fMRI data, a correlation matrix, an adjacency matrix and a functional network according to some embodiments of the present invention.

FIG. 4 is a schematic diagram of a theoretical network according to some embodiments of the present invention.

FIG. 5 is a one-dimensional cellular automaton diagram of ten elements according to some embodiments of the present invention.

FIG. 6 is a space-time diagram generated from a cellular automation according to some embodiments of the present invention.

FIG. 7 is a schematic diagram of a network assault procedure according to some embodiments of the present invention.

FIGS. 8A-8B are schematic diagrams of exemplary networks according to some embodiments of the present invention.

FIG. 9 illustrates brain images of high centrality nodes during rest according to some embodiments of the present invention.

FIG. 10 is a graph of a distribution of high centrality nodes across modules of a resting state network according to some embodiments of the present invention.

FIG. 11 illustrates graphs of the output of a one-dimensional brain cellular automaton given for four different rules according to some embodiments of the present invention.

FIG. 12 illustrates graphs of the density-classification problem on a one-dimensional elementary cellular automaton including 149 nodes.

FIG. 13 is a schematic diagram illustrating nodes and connections according to some embodiments.

FIG. 14 are correlation matrices for brain networks according to some embodiments. Panel a illustrates an original correlation matrix, panel b illustrates the equivalent null₁ model, maintaining the overall degree of distribution, and panel c illustrates the equivalent null₂ model, which is a complete randomization and does not maintain degree distribution.

FIG. 15 are output space-time diagrams using a selection of rules for an ABBM according to some embodiments. Each rule started from the same initial configuration in which 30 randomly selected nodes were turned on. The threshold parameters τₚ and τₙ were set to 0.5.

FIG. 16 are output space diagrams of an ABBM according to some embodiments in which the diagrams began at a randomly generated initial configuration in which 30 nodes were initially turned on. Each panel shows as follows: a: Synchronized fixed point, Rule 98, τₚ=0.3, Σₙ=0.4. b: Fixed point, Rule 98, τₚ=0, τⁿ=1. c: Fixed point with periodic oscillators, Rule 98, τₚ=0.5, τₙ=0.5. d: Fixed point with chaotic oscillators, Rule 97, τₚ=0.4, τₙ=0.2. e: Spatiotemporal chaos, Rule 158, τₚ=0.4, τₙ=0.9. f: Oscillators, Rule 50, τp=0.3, τₙ=0.3.

FIG. 17 illustrates diagrams of attractors of Rule 198 showing the number of unique attractors found at each point in τₚ−τₙ space (left) as well as the frequency of occurrence of attractors sorted by size for the entirety of τₚ−τₙ space (middle) and for two selected points (right).

FIG. 18 illustrates diagrams of attractors of Rule 27 showing the number of unique attractors found at each point in τₚ−τₙ space (left) as well as the frequency of occurrence of attractors sorted by size for the entirety of τₚ−τₙ space (middle) and for two selected points (right).

FIG. 19 illustrates diagrams of attractors of Rule 41 showing the number of unique attractors found at each point in τₚ−τₙ space (left) as well as the frequency of occurrence of attractors sorted by size for the entirety of τₚ−τₙ space (middle) and for two selected points (right).

FIG. 20 shows graphs illustrating a density classification using an ABBM according to some embodiments. The top panel is for a fully connected network, the middle panel is for a thresholded brain network, and the bottom panel is a binary brain network. The fully connected network achieves the highest maximum fitness, does so in the fewest number of GA generations and has the greatest accuracy in classification over a range of densities.

FIGS. 21-22 illustrates density classification graphs using null network models for a fully connected randomized network (row 1), a thresholded null₁ (row 2) and null₂ (row 3) (FIG. 21), and the corresponding binary networks (rows 4 and 5, respectively) (FIG. 22).

FIG. 23 illustrates default mode regions in brain images for determining an ABBM in which white areas indicate regions of interest that are considered to be part of the default mode network according to some embodiments.

FIG. 24A is a time-space diagram for an original network with default mode network nodes initially on using Rule 230.

FIG. 24B illustrates brain images of an average activity of each region of interest using the original network.

FIG. 25A a time-space diagram for an assaulted network with default mode network nodes initially on using Rule 230.

FIG. 25B illustrates brain images showing an average activity of each region of interest using the assaulted network.

FIG. 26A is a time-space diagram for a trained network with default mode network nodes initially on using Rule 230.

FIG. 26B illustrates brain images showing an average activity of each region of interest using a trained network.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

### DEFINITIONS

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

The terms “adaptation and learning” is used to describe specific algorithms that are adopted in the present invention. Adaptation and learning describes an architectural attribute of the present invention. Adaptation and learning describes an architectural structure, process or functional property of the algorithms in which the algorithm evolves over a period of time by the process of natural selection such that it increases the expected long-term reproductive success of the algorithm. Operating in the present invention, the actual computer system operates as a complex, self-similar collection of interacting adaptive algorithms. The present system behaves/evolves according to three key principles: order is emergent as opposed to predetermined, the system's history is irreversible, and the system's future is often unpredictable. The basic algorithmic building blocks scan their environment and develop models representing interpretive and action rules. These models are subject to change and evolution. The exemplary embodiments of the present invention described herein operate using algorithms built on adaptational and learning models. Examples of these algorithms include evolutionary computation algorithms, biological and genetic based algorithms and chaos based algorithms.

In some embodiments, network science and agent-based models (ABMs) may be integrated to evaluate emergent patterns of human or animal brain activity. The models generated may include individual agents (pools of neurons or brain regions) that are interconnected, interdependent, adaptable, and diverse. The agent-based brain models may be mammalian brains, human brains, non-human primates, and/or rodents.

“Interconnectivity” may be determined using network science methods applied to functional MRI data. Time series of images are collected from a subject under various sensory or cognitive conditions. Each time series is then processed to identifying temporal relationships between each imaging voxel and every other imaging voxel. This can be done using linear correlations or through non-linear analyses. Any voxel-pairs exhibiting a strong temporal association are considered to be connected, resulting in a network of functionally connected voxels.

“Interdependency” is the manner in which interconnected agents (voxels in our data) alter the behavior of each other.

For agent-based models (ABMs), “rules” refer to the set of rules that governs the agents' behaviors. In some embodiments, a genetic algorithm may be used to identify the rules for the brain models. Each agent will update its state based on its own current state and a threshold percentage of excitatory and inhibitory neighbors that are active. Agent-based models include models that simulate the actions and interactions of autonomous agents (both individual or collective entities such as organizations or groups) to assess the effects of the sages on a system as a whole.

“Adaptability” may refer to allowing a complex system to generate emergent behaviors. In the brain model, the underlying network connectivity is dynamic based on the cognitive state of the individual. This adaptability comes from the generation of unique networks for multiple cognitive/perceptual states. When a participant is scanned to provide an agent-based brain model (ABBM), multiple cognitive states may be sampled. The network generated from each cognitive state may be unique and imparts adaptability to the model.

“Diversity” may refer to diversity among agents or brain regions and may be used to generate complex behaviors. While there are examples of systems generating complex behavior with identical agents (see John Conway's Game of Life, http://www.bitstorm.org/gameoflife/), emergent behaviors are more likely when agents are diverse. In the agent-based brain model (ABBM) described herein, agent diversity may be achieved through their differences in connectivity. Brain networks have a small number of hubs that garner large numbers of connections while the vast majority of nodes have just a few connections. This range in connectivity inherently makes the agents diverse.

The term “network” is used to describe a set of entities that interact in some fashion. These interactions are defined by a set of connections. The connections have certain attributes that differ based on a specific context. Connection attributes include but are not limited to such things as whether a connection is present or is not in a specific context, the degree or extent of the connection, any conditional logic or rules that dictate the presence or weight of a connection.

The term “neuro-cognitive” defines the type of models in the present invention that is represented and enacted using algorithms and subject to adaptation and learning. Neuro-cognitive models are functional models. These models simulate neurological, psychological or cognitive functions. These models are unique in implementation because they presume connectionism, parallelism, and multiple solutions or outcomes.

The term “context” describes the circumstances and conditions which a specific network that defines the entities, the entity types, the entity attributes, and the connections and the connection attributes. Examples of context include sensory inputs, tasks, and network structure.

Agent based models according to some embodiments are complex networks that facilitate the interaction between autonomous brain regions according to specific rules of behavior in order to perform a specific function or combination of functions. A system for an agent based brain model may be provide by applying the logic of computer science, in particular agent based modeling and advanced artificial intelligence, to the field of network science. Accordingly, agent based models may be used to model physiologically derived brain networks using to produce systems with artificial intelligence (AI) capabilities. For example, a robot may be configured that receives input from a user and/or an environment and outputs an actual robotic action in response using an ABBM as described herein.

Methods

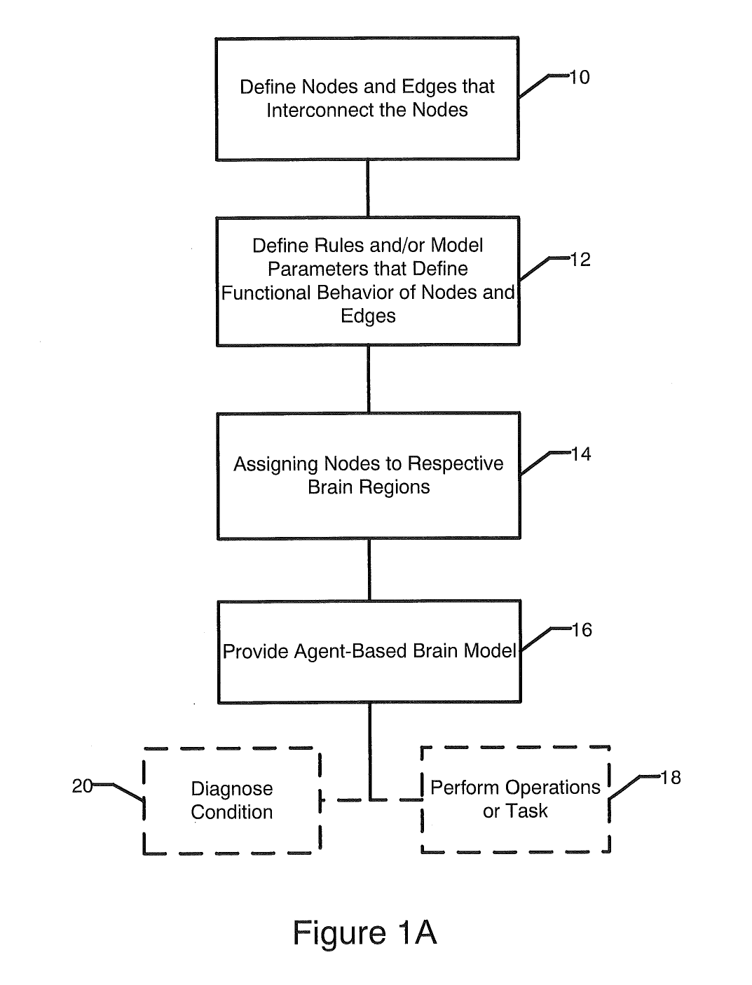

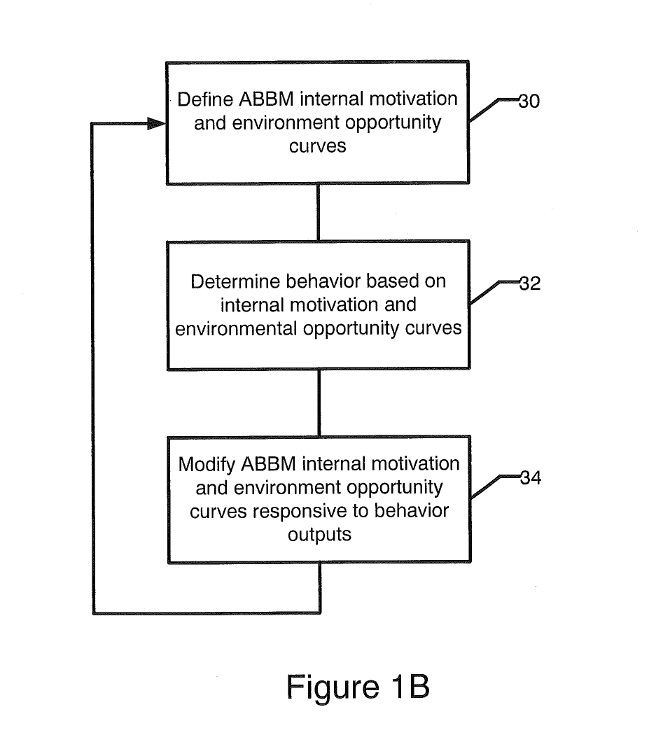

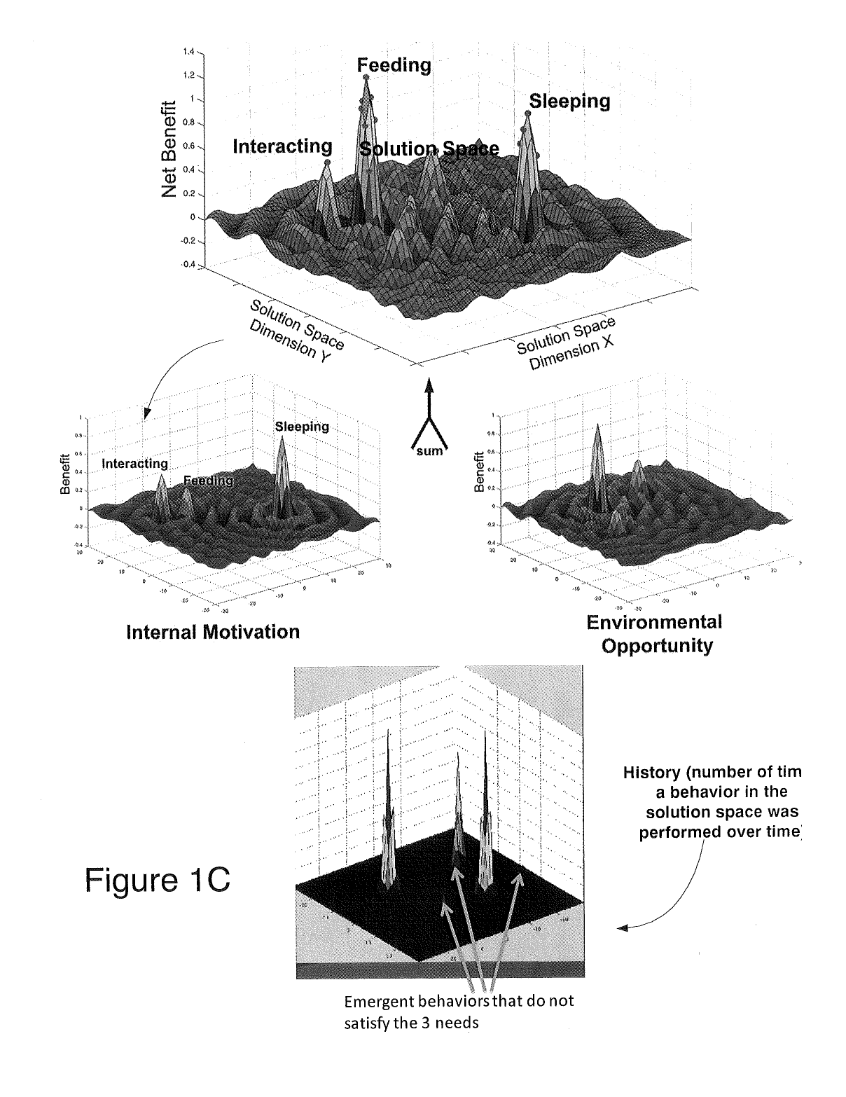

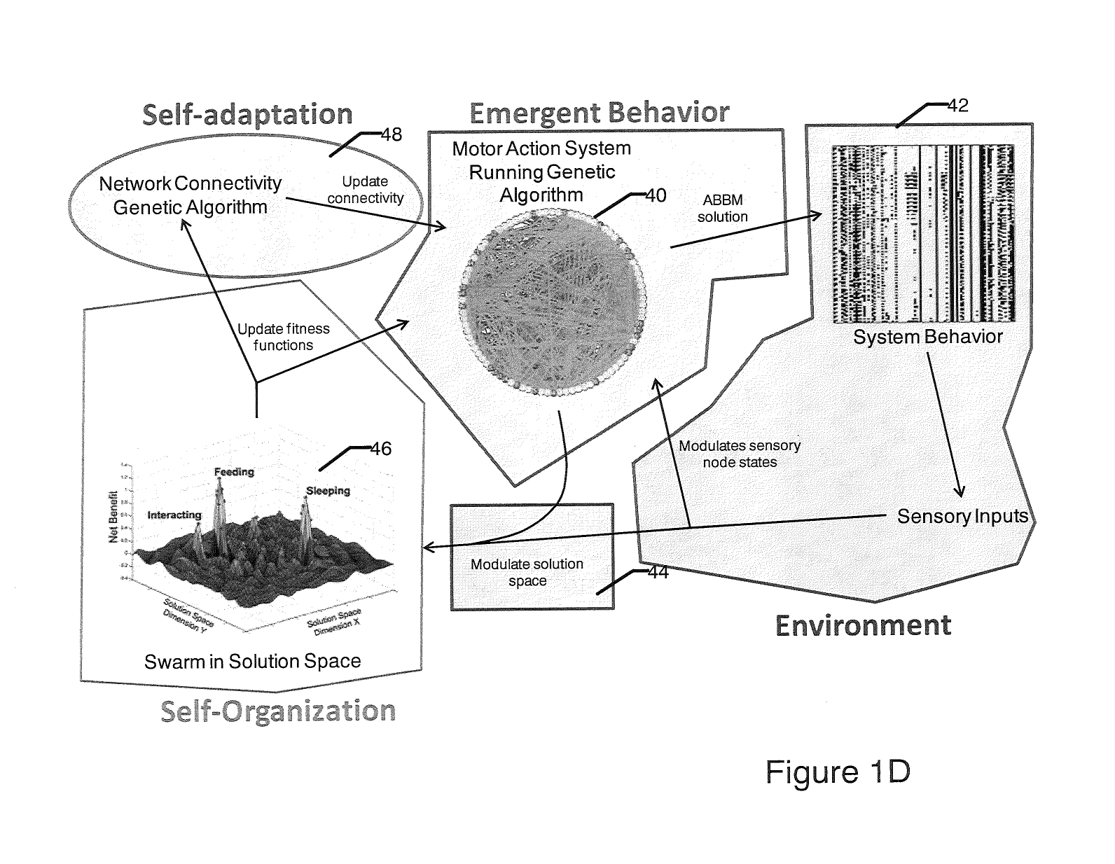

According to some embodiments of the present invention and as illustrated in FIG. 1A, an agent-based brain model (ABBM) is provided. Nodes and edges that interconnect the nodes are defined (Block 10). The edges may be defined by physiological interactions and/or anatomical connections. Rules and/or model parameters define a functional behavior of the nodes and edges (Block 12). The nodes are assigned to respective brain regions (Block 14) and the rules and/or model parameters are defined by observed physiological interactions of the nodes that are functionally and/or structurally connected by the edges of the brain regions (Block 16) to thereby provide the agent-based brain model (ABBM) (Block 18). The agent-based brain model (ABBM) and associated nodes, edges, rules and/or model parameters may be assigned by a computer processor, e.g., running computer program code configured to perform the operations discussed herein, based on actual observed physiological interactions and/or anatomical connections of the brain regions.

In functional networks according to some embodiments, image voxels of the brain are represented by nodes, and correlations between voxel time series are represented by links or “edges” between the nodes. It is noted that in a brain network generated from fMRI data, connected nodes do not need to be spatially contiguous as connections are defined by correlated functional activity rather than location.

The rules and/or model parameters may be determined by genetic algorithms, and the edges may be observed by an imaging modality, such as a structural MRI, functional MRI, EEG, MEG or other imaging modality that can define interactions between brain areas. In some embodiments, the observed physiological interactions may be based on dissection of the brain or other physical observation. The brain regions may be mammalian or non-mammalian brain regions, including invertebrate models.

Embodiments according to the present invention could be used as a research methodology to supplement studies in humans and animal models. The responses of the system can be evaluated for virtually any type of sensory input including auditory, visual, olfactory, touch, temperature, pain, or gustatory stimulations. In addition, the tool could be used to evaluate behavioral and motor response of the brain such as finger-tapping, writing, gripping, muscle flexing, bending, talking, walking, and running.

In some embodiments, the nodes each have a state, e.g., “on” or “off,” and the rules and/or model parameters may be used to update the states, e.g., to perform a task, to generally mimic animal or human behavior, e.g., to provide emergent cognition, thought, or consciousness (FIG. 1A; Block 18). In some embodiments, the agent-based brain model (ABBM) may be used as an artificial model of the brain to study how the brain processes inputs, and produces biologically relevant model outputs, including the following: responses to visual, olfactory, touch, temperature, pain, or gustatory stimulations, and motor tasks such as finger-tapping, writing, gripping, muscle flexing, bending, talking, walking, and running. In some embodiment, the agent-based brain model (ABBM) may be used to produce emergent anthropomorphic properties, including the following: decision making, evaluating morality, consciousness, perception, thinking, mind-wandering, self awareness, motivation, imagination, and creativity.

In some embodiments, the agent-based brain model (ABBM) may be used to produce artificial intelligence capabilities, including the following: pattern recognition, biometrics processing, action planning, route planning, problem solving, data mining, stress detection, adverse event prediction, intelligent character recognition, face recognition, speech recognition, natural language processing, communication, object manipulation, learning, deduction, reasoning, general intelligence, and social intelligence.

Because agent-based brain models (ABBMs) according to the present invention are built upon biological brain networks, there is a the potential to generate emergent behaviors that mimic the human brain. Unlike other models that require training, embodiments according to the present invention may generate spontaneous emergent processes. Potential processes may include cognition, decision making, evaluating morality, consciousness, perception, mind-wandering, self awareness, motivation, imagination, and creativity.

In some embodiments, methods to interface computers with a human or animal brain may be used. Currently, such work is typically directed toward helping disabled persons control prostheses or generate meaningful communication. Embodiments according to the present invention may serve as a link between the brain and computer. Brain signals could be fed into the system and the emergent output could be generated by the model. This output could be used to control a computer or other prosthetic device ranging from limbs to sensory organs, to surrogate interfaces for communication and cognition.

It should be noted that the agent-based brain model (ABBM) may include edges that define either a positive or negative interconnectivity between regions of the brain. For example, if two nodes are positively interconnected, the nodes would have a high likelihood of both being the same state. Stated otherwise, for a positive interconnectivity, when one of the nodes is in the “on” state, then the other node would generally update into an “on” state. For negative interconnectivity, when one of the nodes is in the “on” state, the other node would generally update into an at “off”′ state. In some embodiments, the agent-based brain model (ABBM) may use environmental factors as inputs and may be useful for brain-computer-interface purposes. In some embodiments, the agent-based brain model (ABBM) may be a patient-specific agent-based brain model (ABBM). A patient-specific agent-based brain model (ABBM) may be used to provide a possible diagnosis for various conditions, such as neurological diseases and other conditions based on observed nodes, edges, rules and/or model parameters for the patient (FIG. 1A, Block 20). Many diseases of the brain require a clinical diagnosis because there are no tests that are effective for diagnosis. In particular, diseases of the brain that are complex and not localized to a single brain region have been difficult to identify using traditional imaging techniques. Embodiments according to the present invention may be able to yield individual patient-based models of brain activity. Such a tool may be effective for evaluating how the brain processes information in normal and abnormal conditions. Embodiments according to the present invention may be useful for diagnosis of brain and cognitive disorders such, as but not limited to: Amyotrophic Lateral Sclerosis, Attention Deficit-Hyperactivity Disorder, Alzheimer's Disease, Aphasia, Asperger Syndrome, Autism, Cancer, Central Sleep Apnea, Cerebral Palsy, Coma (Persistent Vegetative State), Dementia, Dyslexia, Encephalitis, Epilepsy, Huntington's Disease, Locked-In Syndrome, Meningitis, Multiple Sclerosis, Narcolepsy, Neurological complications of diseases such as AIDS, Lyme Disease, Lupus, and Pseudotumor Cerebri, Parkinson's disease, Ramsay Hunt Syndrome, Restless Leg Syndrome, Reye's Syndrome, Stroke, Tay-Sachs Disease, Tourette Syndrome, Traumatic Brain Injury, Tremor, Wilson's Disease, Zellweger Syndrome. The diagnosis may include comparing a patient-specific ABBM to a database of ABBMs based on actual clinical experience and patient histories to determine if a patient-specific ABBM is similar to patients having a particular diagnosis or prognosis.

Determining a clinical prognosis for patients with brain and cognitive disorders may be very beneficial patients. Unfortunately, the ability to predict brain function with a disease or after treatment may be difficult with conventional techniques. Embodiments according to the present invention may allow for the generation of patient-specific brain models that can be manipulated to predict outcomes of various clinical interventions. For example, in the case of a brain tumor, the planned surgical resection can be performed on the model and various sensory, motor, or cognitive processes can be tested. Such tests may be used to predict if the intervention will damage critical processing pathways. Prognostic testing could be performed on all disorders discussed above as well as in multiple other brain disorders that can currently be diagnosed with clinical imaging techniques such as: Anoxic Insults, Brain Cancer, Multiple Sclerosis, Parkinson's Disease, Reye's Syndrome, Stroke, Tay-Sachs Disease, Tremor, Wilson's Disease, and Zellweger Syndrome.

As illustrated in FIG. 1B, the agent based brain model (ABBM) may be used to define internal motivation and environment opportunity curves (Block 30). Exemplary internal motivation and environmental opportunity curves are illustrated in FIG. 1C in which the ABBM has internal motivation for actions such as interacting with others, feeding and sleeping. The environmental opportunity is a representation of an environment including objects that are defined to satisfy one or more of the actions defined in the internal motivation curve. The behavior or output of the ABBM may be determined based on the internal motivation and the environmental opportunities curves (FIG. 1B-C; Block 32). For example, as shown in FIG. 1C, the environmental opportunity and internal motivation curves may be summed to determine a solution space or behavior output at any particular time. Accordingly, the ABBM has an ability to interact with its environment. A user may define or modify the environmental opportunities and/or the environmental opportunities may be modified by an automated program. The environment may be changed by adding or removing objects, including people and animals or by modifying defined environmental characteristics such as weather. Each object may be included in a database that tracks how the object modifies the environment and how the object modifies one or more of the internal motivations of the ABBM. When the ABBM behavior is output, it may then modify the motivation and environment opportunity (FIG. 1B-C; Block 32). The number of times that a behavior is performed in the solution space may also be summed. In some embodiments, emergent behaviors occur that do not satisfy the predefined motivations or needs (e.g., sleep, food, interactions).

For example, as illustrated in FIG. 1D, a system includes an ABBM 40, an environment 42, a modulated solution space 44, a swarm output 46 and a network connectivity genetic algorithm 48. The ABBM 40 includes nodes and edges that interconnect the nodes, rules and/or model parameters that define a functional behavior of the nodes and edges, and the edges are defined by physiological interactions and/or anatomical connections. The ABBM 40 provides a behavioral output to a predefined environment 42 based on internal motivations and environmental opportunities. Internal motivations may be defined by meters indicating a need to perform behaviors or potential behaviors, and environmental opportunities may include a measurement of an availability of a behavior, potential behavior, resource or other action. The benefit of performing a behavior or potential behavior is a function of both the internal motivations and the environmental opportunities. The environment 42 in turn modulates the states of the ABBM 40 and the solution space 44, 46. The swarm output 46 updates the connectivity of the ABBM 40 via the network connectivity genetic algorithm 48. Accordingly, the ABBM system may provide artificial intelligence that is self-organize (e.g., generally without an internal or external central leader that decides on a goal or behavior) and self-adaptive (e.g., the ABBM 40 may reconfigure itself generally without external input by interactive with a defined environment according to internal motivations and environmental activities). Moreover, the ABBM 40 may include memory functions that remember the behaviors and the associated benefits such that the ABBM 40 may develop an affinity for a particular behavior on its own and generally without the direction of an external controller.

Accordingly, the ABBM 40 may interact with the environment 42, which may be defined and/or modified by a user and/or defined or modified by an automated algorithm. The environment 42 may include objects, people, animals or modifying characteristics such as weather. The environment 42 may change the ABBM 40 by modifying the solution space 46 and the ABBM 40 may modify the environment 42 by utilizing resources.

In some embodiments, ABBM and environmental interactions may be used to define a model for healthy brain behavior, brain behavior in a disease state, neurological conditions and/or brain injury, e.g., how an ABBM may behave when a stroke occurs or other damage occurs in a particular location. An ABBM that interacts with an environment may also be used for prognosis and treatment planning for a patient with a particular injury in a particular location. The functional brain image data may be used to create a network connectivity genetic algorithm that would be input into the ABBM, and effects of surgical procedures, pharmacological treatments, damage, disease, and/or other conditions could be estimated.

In particular embodiments, the environmental interactions may include an artificial intelligence application. For example, video games may be created in which users may evolve the most intelligent ABBM as a competition. User-ABBM interactions may be logged to determine the most successful methods of making an ABBM evolve with higher artificial intelligence. As another example, an ABBM may be used to define an online filter such that the ABBM “learns” what a particular user wants to see on the internet and provides a personalized feed of things that may be interesting to the user based on part interactions.

Systems and Computer Program Products

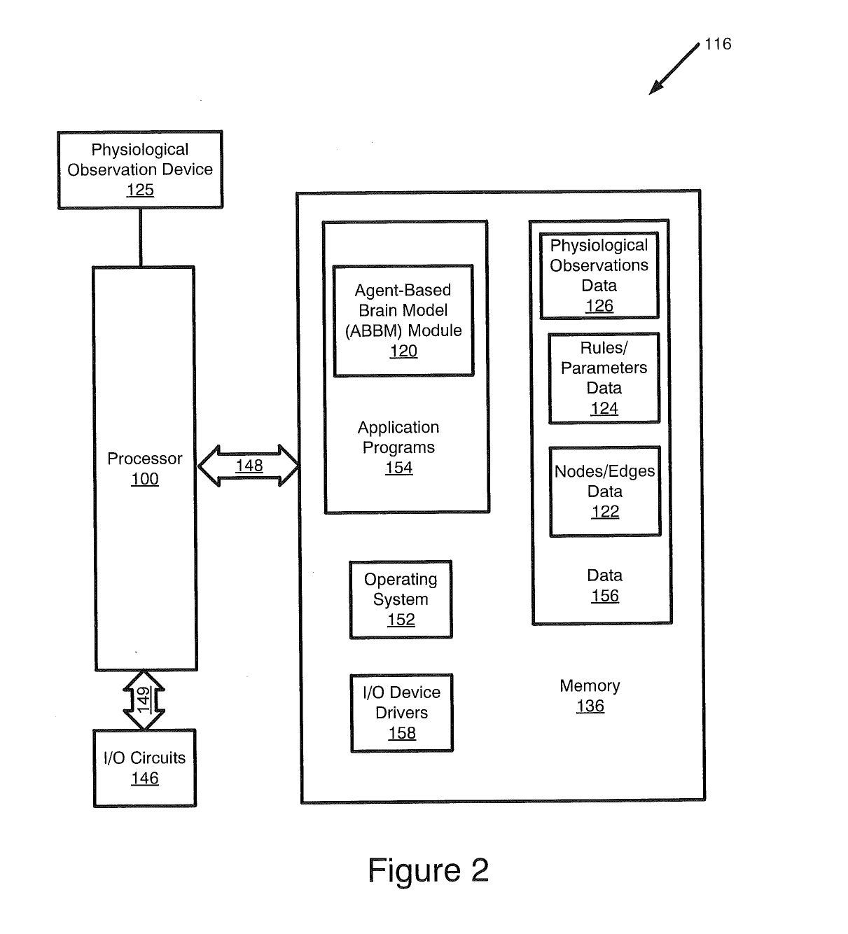

FIG. 2 illustrates an exemplary data processing system that may be included in devices operating in accordance with some embodiments of the present invention and may be used to perform the operations described herein, such as those shown in FIGS. 1A-1B. As illustrated in FIG. 2, a data processing system 116, which can be used to carry out or direct operations includes a processor 100, a memory 136 and input/output circuits 146. The data processing system can be incorporated in a portable communication device and/or other components of a network, such as a server. The processor 100 communicates with the memory 136 via an address/data bus 148 and communicates with the input/output circuits 146 via an address/data bus 149. The input/output circuits 146 can be used to transfer information between the memory (memory and/or storage media) 136 and another component, such as a physiological observation device 125 for observing interactions between brain regions. The physiological observation device 125 may be an imaging modality that may be used to observer or define interactions and interconnections between brain regions, such as a structural MRI, functional MRI, EEG, MEG or other suitable imaging modality. These components can be conventional components such as those used in many conventional data processing systems, which can be configured to operate as described herein.

In particular, the processor 100 can be a commercially available or custom microprocessor, microcontroller, digital signal processor or the like. The memory 136 can include any memory devices and/or storage media containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 can be a content addressable memory (CAM).

As further illustrated in FIG. 2, the memory (and/or storage media) 136 can include several categories of software and data used in the data processing system: an operating system 152; application programs 154; input/output device circuits 146; and data 156. As will be appreciated by those of skill in the art, the operating system 152 can be any operating system suitable for use with a data processing system, such as IBM®, OS/2®, AIX® or zOS® operating systems or Microsoft® Windows® operating systems Unix or Linux™. The input/output device circuits 146 typically include software routines accessed through the operating system 152 by the application program 154 to communicate with various devices. The application programs 154 are illustrative of the programs that implement the various features of the circuits and modules according to some embodiments of the present invention. Finally, the data 156 represents the static and dynamic data used by the application programs 154, the operating system 152 the input/output device circuits 146 and other software programs that can reside in the memory 136.

The data processing system 116 can include several modules, including a agent-based brain model (ABBM) module 120 and the like. The modules can be configured as a single module or additional modules otherwise configured to implement the operations described herein for analyzing the motility profile of a sample. The data 156 can include nodes/edges data 122, rules/parameters data 124 and/or physiological observations data 126, for example, that can be used by the agent-based brain model (ABBM) module 120 to create an agent-based brain model (ABBM) and/or to utilize an agent-based brain model (ABBM) model for performing a task or diagnosing a neurological disease and/or condition, e.g., based on a patient specific agent-based brain model (ABBM).

While the present invention is illustrated with reference to the agent-based brain model (ABBM) module 120, the nodes/edges data 122, the rules/parameters data 124 and the physiological observations data 126 in FIG. 2, as will be appreciated by those of skill in the art, other configurations fall within the scope of the present invention. For example, rather than being an application program 154, these circuits and modules can also be incorporated into the operating system 152 or other such logical division of the data processing system. Furthermore, while the agent-based brain model (ABBM) module 120 in FIG. 2 is illustrated in a single data processing system, as will be appreciated by those of skill in the art, such functionality can be distributed across one or more data processing systems. Thus, the present invention should not be construed as limited to the configurations illustrated in FIG. 2, but can be provided by other arrangements and/or divisions of functions between data processing systems. For example, although FIG. 2 is illustrated as having various circuits and modules, one or more of these circuits or modules can be combined, or separated further, without departing from the scope of the present invention. In some embodiments, the operating system 152, programs 154 and data 156 may be provided as an integrated part of the physiological observation device 125.

The Human Brain Network

In some embodiments, networks can be used to model the structure and function of the human brain by applying network theory to various in-vivo imaging modalities. The brain may be represented as a network comprising many (e.g. 10³ or 10⁴ or more) interconnected nodes. Various imaging techniques, such as MRI methods including diffusion tensor imaging (DTI) and diffusion spectrum imaging (DSI) may be used to create structural networks based on axonal fiber orientation in brain white matter. Magnetoencephalography (MEG) and fMRI may be used to acquire functional information about the brain used to produce functional connectivity networks. In functional networks according to some embodiments, image voxels are represented by nodes, and correlations between voxel time series are represented by links or “edges” between the nodes. It is noted that in a brain network generated from fMRI data, connected nodes do not need to be spatially contiguous as connections are defined by correlated functional activity rather than location.

Without wishing to be bound by any particular theory, the functional brain network has been found to be assortative, meaning that foci in the brain that have a large number of connections are generally interconnected to other well-connected foci. Nodes in the brain network also show local community structure, which can be thought of as neighborhoods of nodes that are more tightly interconnected among themselves than with nodes outside of their neighborhood. A metric called modularity may be used to make highly accurate approximations of this community structure. See Newman M E (2004) Fast algorithm for detecting community structure in networks. Physics Review 69: 066133. Modularity analysis in brain imaging allows for identification of neighborhoods that are consistent with known structure/function relationships in the brain. Network science methods may be used for the evaluation of complex emergent processes that cannot be identified by focusing on a single brain area.

The Default Mode of the Brain

The brain may be investigated in a resting or non-resting state. The “resting” state brain is generally not completely inactive, but the activity generally occurs consistently in particular regions. These regions are the precuneus, lateral parietal cortex, medial frontal lobe, and lateral frontal lobe. These regions may exhibit strong correlations in functional MRI (fMRI) data collected at rest. The baseline level of neuronal activity seen in these areas has been termed the brain's default mode. The baseline metabolic activity exhibited by these regions at rest is suspended when a subject initiates a task, for example a working memory task or a visual task. Without wishing to be bound by theory, is currently believed that this baseline activity serves a functional purpose. For example, default mode regions have been linked to offline memory reprocessing, a process in which the brain suppresses information from the outside world and searches older memories for information that is useful to newer ones. In fact, offline memory reprocessing that occurs in these default mode regions might be why people daydream. Furthermore, changes in resting state processes in the default mode have been investigated as biomarkers for brain abnormalities such as schizophrenia, autism, attention-deficit/hyperactivity disorder, and Alzheimer's disease. The “default” mode sets several expectations and provides a prediction of how the healthy brain should behave at rest.

Network Generation from Imaging Data

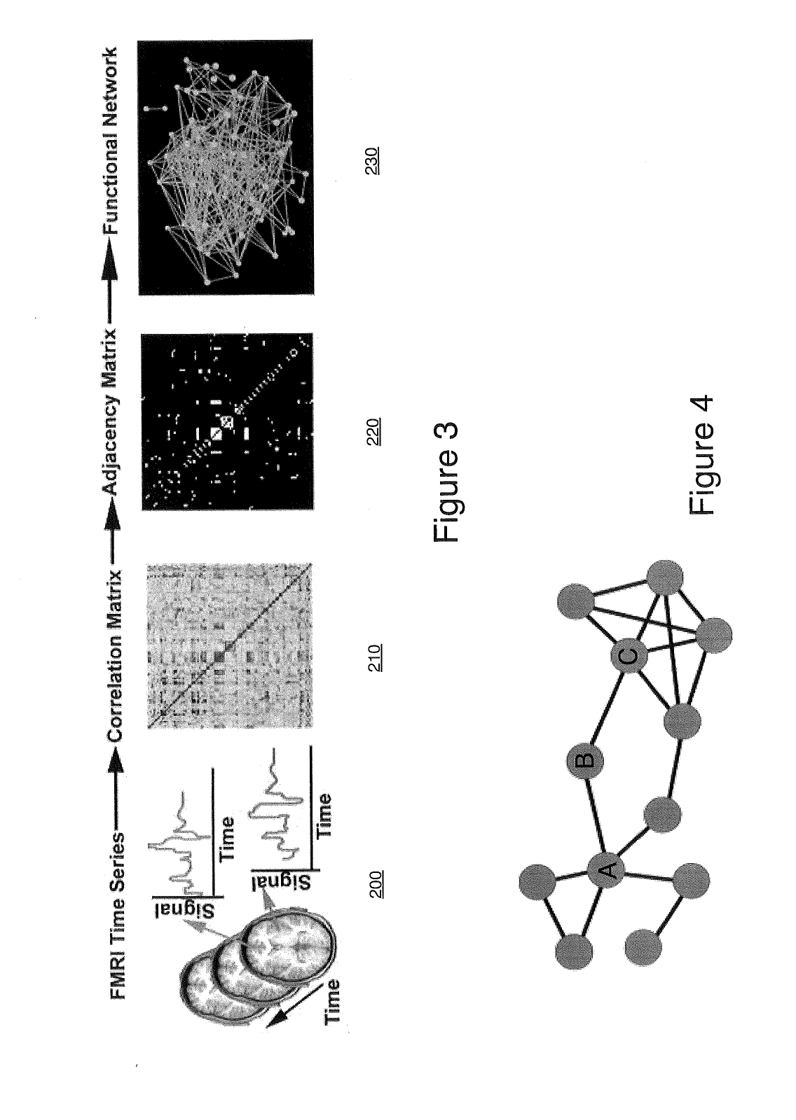

FMRI data sets previously collected at rest from 20 healthy subjects aged 18-38 years (mean 28) from a previous study were used. See Castellanos F X, Marguiles D S, Kelly C, Uddin L Q, Ghaffari M, et al. (2008) Cingulate-precuneus interactions: a new locus of dysfuntion in adult attention-deficit/hyperactivity disorder. Biol Psychiatry 63: 332-337. These data were collected using a 1.5 T GE twin-speed LX scanner with a birdcage head coil (GE Medical Systems, Milwaukee, Wis.). Voxel size was 3.75×3.75×5 mm. All data were collected with IRB approval. Data from these subjects have been analyzed using a processing stream (FIG. 3) to generate the networks that will be used. FIG. 3 illustrates images representing exemplary techniques for culling network data from images in order to define ABBM architecture according to some embodiments. FMRI data are collected from a subject (Image 200). Correlations between region time series are calculated in a correlation matrix (Image 210) and an adjacency matrix is calculated (Image 220) such that if two regions are correlated, there is a functional connection between individual foci. The functional network is thereby defined as nodes (brain regions) and edges (functional correlations) (Image 230).

In some embodiments, to generate networks, 3D fMRI time series data sets for each subject may be used to extract time courses, for example, for each of approximately 16,000 gray matter voxels. Correlations were then computed between each voxel time course and used to populate a correlation matrix. A threshold was applied to the correlation matrix, above which individual voxels are determined to be connected. This results in a binary adjacency matrix, with 1 indicating the presence and 0 indicating the absence of a connection between two nodes. These binary voxel-wise data sets may be utilized in investigations of the centrality of network nodes. 90-node region of interest (ROI) data sets are used in the agent based model (ABM). ROI segmentations may be based on the automated anatomical labeling (AAL) atlas, which provides anatomical divisions of brain regions. An ROI time series is calculated by averaging the time series of voxels falling within a particular ROI. These ROI time series may then be used to compute the correlation matrix in a similar manner as the voxel-based network in FIG. 3. The resulting correlation matrix among ROIs is used as an input to the ABM. These data sets provide a computationally feasible model that can later be extended to voxel-wise data sets.

Network Analyses on Unweighted Voxel-Wise Networks

Once a functional network has been formed, several analyses may be performed. The following descriptions of analyses focus on binary voxel-wise networks. However, many of these analyses may be applicable to weighted graphs as well. More detailed descriptions can be found in a previous publication. See Joyce K E, Laurienti P J, Burdette J H, Hayasaka S (2010) A New Measure of Centrality for Brain Networks. PLoS ONE: One of the most straightforward network metrics is node degree (k), defined as the number of edges connecting a node to other nodes in the network. The distribution of node degrees contains information on the abundance of nodes with a given degree. The degree distributions of brain networks indicate that most nodes in the network have relatively low degree, but there may be a handful of nodes that have extremely high degree. Such nodes may be termed “hubs,” and are particularly prevalent in the precuneus and posterior cingulate of the brain, regions often regarded as the core of the brain network.

The clustering coefficient (C) is a measure of the interconnectedness of a node with its neighbors, and quantifies the number of connections that exist between neighbors of a node compared to the total possible number of connections. As a social network example, clustering quantifies the likelihood that your friends are also friends with each other. Path length (L) is used to describe the number of intermediary edges connecting two nodes. The average path length between any two nodes in the network describes efficacy of information exchange on a global scale. As path length decreases, intuitively the efficiency of information exchange increases. The brain is part of a particular class of networks characterized by highly interconnected neighborhoods and efficient long-distance “short-cut” connections, connecting any two nodes in a network with just a few intermediary connections. Such a class of networks may be called small-world networks. Small-world networks, such as the brain network, exhibit advantageous qualities of low path length enabling distributed processing, and high clustering enabling local specialization. See 49. Watts D J, Strogatz S H (1998) Collective dynamics of ‘small-world’ networks. Nature 393: 440-442; Strogatz S H (2001) Exploring complex networks. Nature 410: 268-276.

Several metrics may be used for the purpose of quantifying the importance of any particular node within an entire network. These centrality metrics seek to identify nodes that are likely to be highly influential over the behavior of the network, and are in the mainstream of information flow. Degree is one such metric, and defines central nodes to be those having the highest number of connections. Degree assumes that the importance of a node in the network is dictated by the number of other nodes with which it directly interacts. On the other hand, betweenness centrality (BC) considers nodes that are between many pairs of other nodes to be the most central in the network. In other words, a person may be central if they are strategically located between pairs of other people—i.e. a middle man. Nodes with high betweenness centrality therefore control the flow and integrity of information. This assumes that information travels along the shortest path, and only a single path. Eigenvector (EC) centrality is a unique centrality measure as it considers the centrality of immediate neighbors when computing the centrality of a node. Mathematically, eigenvector centrality is a positive multiple of the sum of adjacent centralities. Essentially, this means that a node is considered to be highly central if it is connected to high degree nodes. However, eigenvector centrality does not take into account the degree of a node relative to its neighbors (i.e. assortative behavior), which may have very important implications.

FIG. 4 is a theoretical network demonstrating nodes with high leverage (A), betweennes (B), and degree and eigenvector (C) centralities. FIG. 4 gives the example of a 50% threshold for both excitatory and inhibitory neighbors. A number of rules may be defined for each percentage threshold. As illustrated, a total of 256 rules are possible for each percentage threshold. A genetic algorithm may be used to identify the optimal thresholds and to discover the rule that achieves the greatest system fitness.

Although the centrality metrics discussed above have been clearly demonstrated to be useful for particular applications, other appropriate methods for the brain may be used given the current knowledge of the function and structure of the brain as a network in some embodiments.

In some embodiments, a centrality metric may be used that is described herein as a “leverage centrality,” which reflects local assortative or disassortative behavior of the network, does not assume information flows along the shortest path or along a single path, and is defined on the interval [−1,1], making inter- and intra-network comparisons straightforward. Furthermore, leverage centrality is not computationally burdensome, and as such can easily be computed for networks containing on the order of 10⁴ nodes or more. The computation may be as follows: for node i with degree K, connected to the set of neighbors Nᵢ, each having degrees leverage centrality is computed by the following equation:

$${LC}_{i} = \frac{1}{{K}_{i}} {\sum }_{{N}_{i}} \frac{{K}_{i} - {K}_{j}}{{K}_{i} + {K}_{j}}$$

Essentially leverage centrality is a measure of how the degree of a given node relates to its typical neighbor. A node with negative leverage centrality is influenced by its neighbors; it has little leverage over the behavior of its neighbors because it interacts with fewer nodes than its neighbors. A node with positive leverage centrality influences its neighbors; it does have leverage over the behavior of its neighbors because it interacts with more nodes than its neighbors. Consider the example network shown in FIG. 4. Node A has a higher degree than its neighbors and therefore has high leverage centrality. In contrast, although node B has high betweenness since it acts as a bridge between nodes A and C, it has negative leverage centrality since its degree is low relative to its neighbors. Node C has both high eigenvector centrality and high degree, but its leverage centrality is approximately zero since it likely does not exert much influence over its neighbors, whose degrees are very similar. Node A is of interest because it interacts with relatively many nodes, each of which has a low degree. Thus node A appears to have influence over them.

Representing Complex Systems with Agent Based Models

A complex system may be characterized by interconnected components which may be relatively simple, but when assembled as a whole exhibit emergent behavior that would not be predicted based on the behavior of each individual component alone. In other words, the emergent behavior of the system is not a simple sum of behaviors of all the components making up the system. The brain may be considered an example of a complex system. A complete understanding of the biochemical processes that underlie the behavior of an individual neuron may not produce an explanation for processes such as decision making and emotion. However, by modeling the way neurons interact with each other en masse, a “bottom-up” modeling approach may be able to reproduce some of the complex behaviors seen in the brain. One such bottom-up method is agent based modeling. In general, agent based models (ABMs) includes agents, i.e. players on the playing field, and the rules that govern their behavior. For example, the Boids simulation is an ABM in which the players are birds and the very simple rules they obey are cohesion (fly close to your neighbors), separation (not too close), and alignment (in the same direction). These very simple rules will, over a few time steps, form a coordinated flock out of any random initial configuration of birds. The crucial component to the design of an ABM is determining the rule, or rules, that govern the agents. In some embodiments, the agents are nodes of the functional brain network constructed from resting state data, and the ideal rule will produce resting state functional activity that mimics the default mode.

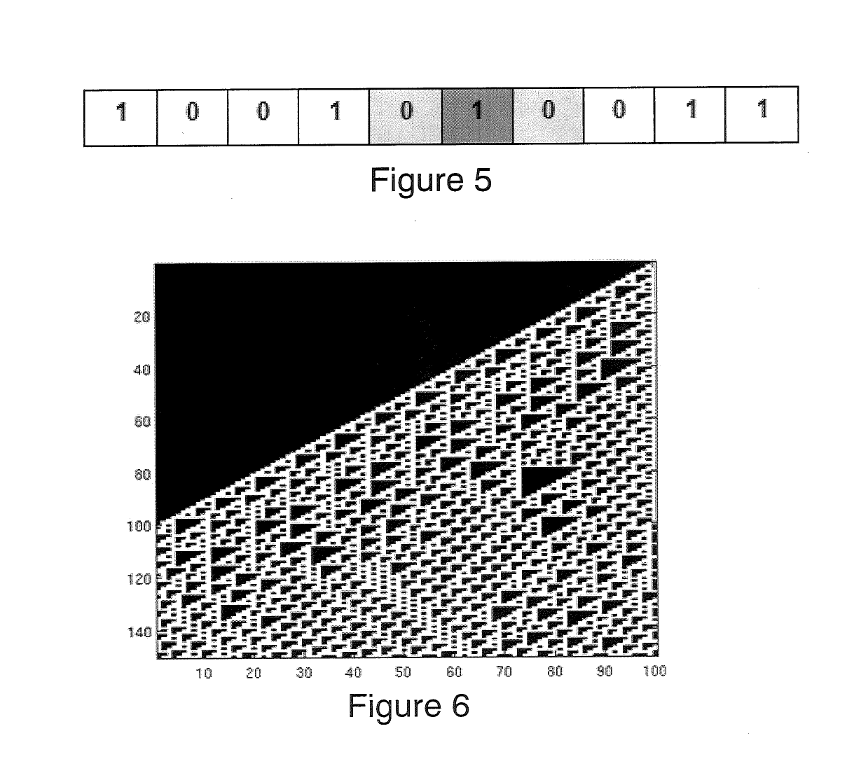

A cellular automaton (CA) is a special case of an ABM, where agents are cells arranged on a 1D line or a 2D plane, and are allowed to interact with the cells in their neighborhood. An example 1D CA is shown in FIG. 5. Each cell can have a particular state, on or off represented by 1 or 0. The dark blue cell in the figure is in the on state, while each of its direct neighbors in light blue are in the off state. Given 2 possible states (on/off) and a neighborhood of size 3 (left neighbor, self, right neighbor), 2³=8 possible combinations exist. Those combinations are shown as the “neighborhood” in Table 1, commonly referred to as a rule table. The top row displays the 8 possible neighborhoods, and the bottom row displays the state that a cell having that neighborhood will take in the next time step. A CA may then be iterated over time steps, where all cells are updated simultaneously. The rule shown in Table 1 is just one example, and in fact there are 2⁸=256 possible rules for a neighborhood of size 3. Often the results of 1D CA are displayed in a space-time diagram. The space-time diagram for this rule (Rule 110) is shown in FIG. 6.

As shown in FIG. 6, a space-time diagram may be generated. As illustrated, the space-time diagram is generated from a CA with 100 cells. Each horizontal row represents the state of every cell in the system at one instant. White cells are on and black cells are off. Rule 110 dictated the state of any given cell in the next time step based on its immediate left- and right-hand neighbors. The system was iterated over 150 time steps.

Role of Genetic Algorithms in ABM Design

When solving a complex mathematical problem, exhaustively searching the solution space can be highly computationally taxing. Alternatively, one might devise a method of searching the solution space without having to explore all possible solutions. One such alternative approach is to use genetic algorithms (GAs). GAs exploit the concept of evolution by combining potential solutions to a problem until an optimal solution has been evolved. In general, a GA begins with an initial population of individuals—chromosomes, or solutions. The suitability of these individuals as solutions to the given problem is evaluated, quantified by a fitness function. Typically the fittest individuals, those that produce the highest fitness, survive and produce offspring. Each offspring is a new solution including parts taken from the parents, ideally incorporating desirable characteristics from both. Offspring may be subject to mutations, which diversify the genetic pool and lead to exploration of new regions of the solution space. Mutations that increase the fitness of an individual tend to remain in the population, as they increase the probability that those individuals will produce offspring. This process of evaluating fitness, selecting parents, producing offspring, and introducing mutations is repeated for a number of generations. A general outline of a GA is shown below.
1. Initialize population. Begin with nC chromosomes generated at random.
2. Test population. Test each of nC chromosomes by calculating fitness.
3. Rank population by fitness. The fittest nCross individuals are selected for crossover.
4. Cross individuals. Cross the nCross individuals until the initial population size nC is obtained.
5. Mutate offspring. Offspring are subject to mutation at a probability pₘ.
   Repeat 2-5 until stop.

Each of the above five steps may have variations, and there may be more than one suitable algorithm for a given problem. The size of the initial population, the number of individuals to cross, and the number of generations over which to run the algorithm are all important factors. Increasing any of these increases the chances of converging on an accurate solution, but also increases computational costs. Many other factors influence the outcome of the GA. For example, the number of individuals to cross may be based on the percentage of top performers, or may be based on the absolute fitness value. Once the selection pool has been established, pairing individuals may be done at random or by a number of methods based on fitness rank, and individuals may or may not be placed back into the selection pool after crossing. The mutation rate may also be varied. Increasing the rate increases genetic diversity and prevents initially strong individuals from dominating the population. On the other hand, a high mutation rate also decreases resemblance of offspring to their fit parents. Determining an appropriate fitness function is key, as the fitness of an individual determines whether or not it is a successful solution.

The GA parameter optimization problem has been described as a balance between exploration and exploitation. Exploiting good solutions may take advantage of current knowledge, but narrows the search space to a locally specific region. On the other hand, exploration encourages a search for more distant solutions but ignores feedback on good solutions found earlier in the search. In some embodiments, a GA may be used to evolve an optimal rule for the CA, and each individual may be binary strings representing several variables of the CA, including the rule table.

Design and Methods: Using Leverage Centrality, Identify Regions of the Brain that are Relatively Important to Information Flow Through the Functional Brain Network.

Network Assault

In some embodiments, regions of the brain that are relatively important to information flow through the functional brain network may be identified using leverage centrality. For example, the impact of damage to the brain network may be compared when highly central nodes have been removed. Central nodes may be identified using each of the four centrality metrics described herein. Damage may be simulated by removal of these highly central nodes so that they can no longer play a part in information transfer through the network. This targeted removal of nodes, or assault, may result in changes in the network topology, and the small-world properties of the networks may decline. This decline in small-world-ness will be evaluated by measuring network clustering (C) and path length (L) for the 20 brain networks before and after network assaults. Targeted assault may be compared to random deletion of the same proportion of nodes.

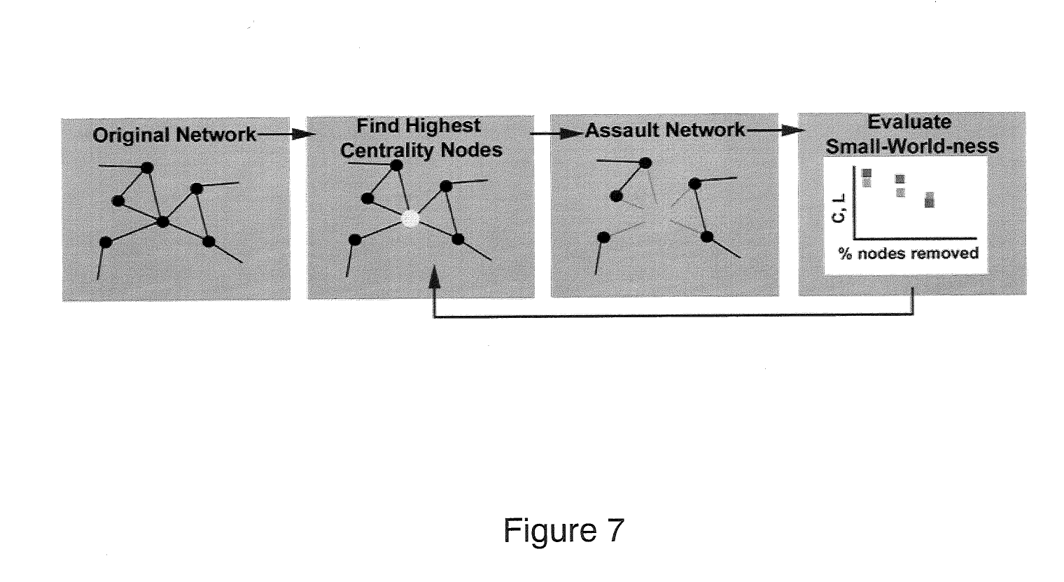

An exemplary diagram illustrating a network assault is shown in FIG. 7. In each network, a percentage, such as the 2%, of the highest degree, leverage, betweenness, and eigenvector centrality nodes may be identified. These nodes may then be removed, and C and L will be recalculated for each modified network after each successive iteration, until a desired percentage, such as 20% of the total number of nodes have been removed. A one-way ANOVA analysis across 20 subjects with centrality type as the main factor may be performed for both C and L. The analysis may compare the metrics at each level of node removal (2%-20%). Post-hoc t-tests may be used to identify the factors and direction of difference driving significant results in the ANOVA. This analysis may be used to provide evidence that high leverage nodes may play an important role in maintaining the structural integrity of the functional brain networks.

Leverage centrality may identify nodes that are highly influential over other nodes in the network, and high leverage centrality nodes may be more likely to be hubs than high degree, betweenness, or eigenvector centrality nodes. The high leverage nodes may play an important role in the topological organization of brain networks. Again without wishing to be bound by any particular theory, it is hypothesized that the removal of high leverage nodes may result in greater fragmentation of the network than caused by the removal of nodes based on other centrality metrics. Specifically, targeted assault of high leverage nodes may increase L very rapidly since many low degree nodes that depend on high leverage nodes may be disconnected from the continuous graph. As nodes become isolated, both C and L are detrimentally impacted.

Alternatively, because of their abundant connections, the removal of high degree nodes from the network may break the graph up to such a large extent that both C and L may be very detrimentally impacted. However, even if this is the case, the change in network structure may not be reflecting the importance of nodes that are necessary for information transfer in the brain. An alternative methodology is to measure the ability of information, or a signal, to spread through the network after successive iterations of node deletion. A spreading activation scheme could be modified to this end. For example, in this method, a network is perturbed by injecting energy (activation) into a subset of the nodes at time t=0. The activation of a given node at time t=1 and in each subsequent time step is dependent on the activation of all of its immediate neighbors. The control parameters α and γ manage the rate of activation transfer from one node to the next (a) and the rate of relaxation of each node (γ). For low values of the ratio α/γ, the system will asymptotically settle to a low value of total activation. For higher values of α/γ, the system is unable to settle. By varying the ratio α/γ, a critical transition point at which the system fails to settle may be identified. Monitoring this critical transition point as the network is subject to targeted assault will provide insight into the role of high leverage nodes in spreading activation through the system. If high leverage nodes are most important to information transfer, their removal will increase the α/γ transition point to a greater extent than the other centrality metrics.

Modular Structure

In some embodiments, the spatial distribution of high leverage nodes throughout network modules may be observed. Analysis may be performed, e.g., in the 20 human brain networks collected from subjects at rest. The experiment includes two components. First, an assessment of the spatial distribution of high centrality nodes across modules may be accomplished for each centrality type. The network may be broken into individual modules using a calculation and the centrality of each node within the isolated sub-networks may be computed. Correlation analyses may be used to evaluate the change in centrality before and after dividing the network. A high correlation for a given centrality measure indicates that nodes considered to be highly central are both central in terms of the network as a whole and also central in terms of their native module. It is hypothesized that leverage centrality can identify these nodes.

A percentage of the highest leverage nodes may be removed from the network. This percentage may be incremented in steps of 2% with a maximum of 20%; however, it should be understood that other percentages may be used. After the allotted percentage of nodes are removed, the network may be processed using the modularity calculations again in order to assess the role of high leverage centrality nodes in driving local network structure. A comparison may be made of the modularity of the original network and the modified network without high leverage centrality nodes. This process may be repeated for the other centrality metrics as well. All of the nodes within a given network may be analyzed for each of the four centralities in terms of their neighbors, with neighbors defined to be the set of nodes that belong to the same module. Computed are (1) the number of neighbors that are lost from the module, excluding deleted nodes, (2) the number that are added to the module, and (3) the number which remain in the same module. This provides a straightforward measure of the change in network modularity due to removing high leverage nodes versus the other centrality metrics. Three one-way ANOVAs with centrality metrics as a factor may be performed at each percentage of nodes removed, analyzing the number of nodes that stayed in the same module, the number of nodes that left each module, and the number of nodes that were gained by each module. These ANOVAs may summarize the difference in modularity imposed by removal of high centrality nodes.

It is hypothesized that high leverage nodes are located throughout the network in most modules, as they are essential to neighborhood structure. Preliminary results are in support of this hypothesis (see FIG. 10). Because they are distributed throughout, the removal of high leverage nodes may drastically disrupt local structure throughout the network. It is expected that division of the network by the modularity computations may be distinctly different after the removal of high leverage nodes. Analyses may show that the number of nodes which remained in the same module may be lowest, and the number of nodes lost and gained may be the highest after removing high leverage nodes.

Some modules may have an absence of high leverage nodes. These modules are likely to have clusters of interconnected high degree nodes. Conversely, high leverage centrality nodes may have a large presence in a particular module. These modules may be of particular interest, as they may be areas of the brain that are extremely important for information communication; the loss of nodes in this region would be extremely detrimental. Those modules having a lower proportion of high leverage nodes than high degree nodes may retain community structure due to high degree nodes. These high degree nodes may be forming a structural core with many redundant connections, and are likely to be found in the area of the posterior cingulate cortex and precuneus.

ABMs may be used to model the resting state brain by utilizing weighted and undirected 90-node ROI based networks. A CA has been constructed for this purpose, where each of 90 cells represents a single ROI. Each cell has a neighborhood, e.g., of size 3, including a self, a positive neighbor cell, and a negative neighbor cell. The positive neighbor cell represents the sum effect of all positive neighbors of the node, where the positive neighbors are defined to be the set of nodes (i.e. ROIs) that are immediately adjacent to the node of interest and have a positive correlation coefficient. The negative neighbor cell represents the sum effect of all negative neighbors of the node, the set of nodes that are immediately adjacent to the node of interest and have a negative correlation coefficient. By collapsing all positive and negative neighbors into a single aggregate positive or negative cell, the complex arrangement of nodes and edges of the brain network can be flattened into a one-dimensional CA. This 1D model captures the heterogeneity in the connectivity of the nodes by allowing inputs from all adjacent nodes, but does not require that all inputs be modeled explicitly. A CA modelling all connections individually would be intractable at this early stage.

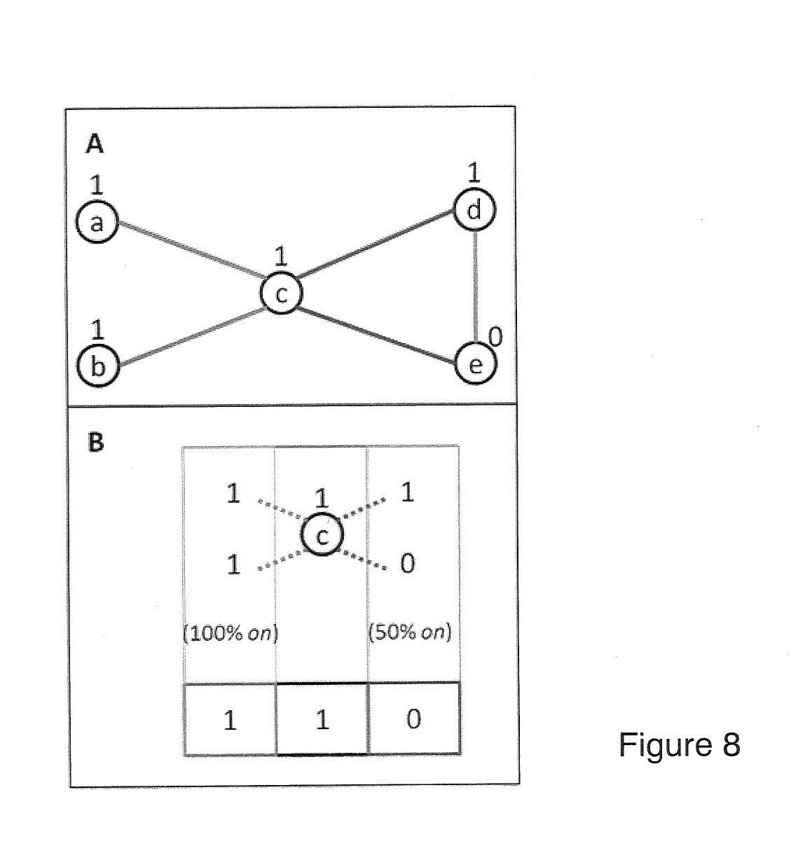

FIGS. 8A-B are schematic diagram illustrating a depiction of the determination of a node neighborhood (FIG. 8A) in an exemplary network according to some embodiments. Blue lines indicate positive connections, red lines indicate negative connections, and the state of each node is indicated by 1 or 0. In FIG. 8B, the neighborhood of node c may be determined by applying a threshold on the percentage of positive and negative nodes that are on.

The process of creating the 1D CA is illustrated in FIGS. 8A-8B. FIG. 8A contains an example network includes five nodes. Positive connections between nodes are denoted by blue lines, and negative connections are denoted by red lines. The state of each node is indicated by a 1 (on) or 0 (off) above each node. By considering each node in turn, the 3-bit neighborhood may be determined. FIG. 8B depicts the process of determining the neighborhood for node c. In this example, node c has two positive neighbors, 100% of which are on, and two negative neighbors, 50% of which are on. An arbitrary threshold has been applied such that at least 60% of the positive or negative nodes must be on in order for the positive or negative bit to be a 1. In this case, the positive percentage is above this threshold, and therefore the positive bit is a 1, while the negative percentage is not and therefore the negative bit is a 0. Once the brain can be collapsed into a 1D CA, a rule can be used to iterate over time steps and drive the behavior of the system.

Several parameters of the CA are unknown at this time. Initially a correlation matrix of an ROI based network is read into memory. This network includes a 90-node graph with weighted edges. A threshold is applied to the edge weights to determine whether or not they are included in the network. This thresholding process is similar to that used in the voxel-wise networks in order to convert the correlation matrix into a binary adjacency matrix (see FIG. 3). However, unlike the binary voxel-wise networks; connections that survive the thresholding process retain their weighted values. The positive and negative neighbors of all nodes are collapsed into a positive neighbor cell and negative neighbor cell, via the thresholding process discussed above and in FIG. 8. Based on the 3-bit neighborhood of each cell, a rule may dictate the next state of each cell. The five unknown CA parameters are summarized below.

Unknown 1: Positive edge weight threshold. Positive connections with weights between this threshold and 0 are removed from the network.

Unknown 2: Negative edge weight threshold. Negative connections with weights between this threshold and 0 are removed from the network.

Unknown 3: Aggregate positive neighbor threshold. If the percentage of positive neighbors of a node that are in the on state is greater than or equal to this value, the positive neighbor cell has a value 1.

Unknown 4: Aggregate negative neighbor threshold. If the percentage of negative neighbors of a node that are in the on state is greater than or equal to this value, the negative neighbor cell has a value 1.

Unknown 5: 8-bit rule used to drive the CA. Each bit corresponds to the next state of the cell based on the neighborhoods listed in Table 1.

TABLE 1

| | Neighborhood | | | | | | | |
|---|---|---|---|---|---|---|---|---|
| | 000 | 001 | 010 | 011 | 100 | 101 | 110 | 111 |
| Next State | 0 | 1 | 1 | 0 | 1 | 1 | 1 | 0 |

A GA may be used to solve for unknowns 1-5 by encoding each unknown as a binary string on the chromosomes in the GA population. In other words, each unknown is represented by a binary string, and concatenating the 5 binary strings forms a continuous chromosome. Chromosomes of the initial population may be randomly generated such that each unknown is linearly represented across its entire possible range. The population size may be any suitable number, and in this case, may be 100 chromosomes. The CA begins at some randomly generated initial configuration of on and off nodes. The fitness of each chromosome in the population may be evaluated by running the CA under the variables encoded in each chromosome, and repeated for 100 unique initial configurations. The chromosomes with the top 20% fitness averaged over all 100 initial configurations may be selected for crossover. The bottom 80% of the population may be removed from the population. The discarded individuals may be replaced by crossing the fittest individuals from the original population. Crossover may be based on a roulette wheel selection protocol [60] with the fittest individuals having the greatest probability of participating in the crossover to generate the offspring population. Crossover may occur both at locations between variables and within variable strings at a crossover probability of 60%. Each resulting offspring may be mutated at a random location on the chromosome at a probability of 0.5%. This new population may be tested on a new set of 100 initial configurations. The proposed fitness function for evaluating chromosomes is shown in the equation below, which summarizes the Hamming Distance between the desired CA output and the true CA output.

$$f = \frac{1}{N} {\sum }_{i = 1}^{N} \vert {DMN}_{i} - {DMN}_{i}^{′} \vert {α}_{i}$$

In the above equation, DMNᵢ denotes the state of node i in the desired default mode network, DMNᵢ′ denotes the average state of the node i over the final n_{avg} iterations of the CA, αᵢ denotes the weight of a node i, and N denotes the number of nodes in the system. Note that there are 8 nodes in the DMN out of the total 90 nodes in the brain network. The average over the last n_{avg} iterations is used in the calculation of DMNᵢ′ because the brain does not reach a constant steady state during rest, but exhibits complex oscillatory patterns of nodes becoming active and inactive. This is consistent with the real brain where individual neurons do not necessarily turn on or off but oscillate between periods of relative activity and inactivity. The weight αᵢ is simply a linear transformation of leverage centrality given by αᵢ=LCᵢ+1. This weight is designed such that high leverage nodes that are in the incorrect state may cause a greater impact on the fitness function than low leverage nodes in the incorrect state. Individuals with fitness closest to 0, i.e. low Hamming Distance between the desired output and actual output, are considered to be the fittest.

GA parameters such as the population size, crossover rate, mutation rate, and number of generations are often problem-dependent, and it can be difficult to estimate appropriate values for these parameters without prior information. To obtain a better estimate of the GA parameters for this particular system, the GA may first be used to solve a previously described density-classification problem in the brain CA. See Mitchell M (1998) An Introduction to Genetic Algorithms. Cambridge: MIT Press. The goal of the density-classification problem is to find a rule that can determine whether greater than half of the cells in a CA are initially in the on state. If the majority of nodes are on (i.e. density>½) then by the final iteration of the CA, all cells should be in the on state. Otherwise, all cells should be turned off. This problem has been successfully replicated for a 1D elementary CA with 149 nodes (see section D.4 of Preliminary Results). However, the brain CA is not truly an elementary CA, as the behavior of a given cell does not solely depend on its immediate neighbors. Testing the density classification problem on the brain CA allows for exploration of appropriate GA parameters for the brain CA using a well-described problem with a known fitness function. Initially, the GA parameters for solving the density problem in the brain CA may be set to those used to solve the problem in the elementary CA, but may be altered as necessary if the model is not successful.

A rule and a set of parameters for the CA that replicates the behavior seen in resting state functional brain network may be obtained. It is likely that there may be multiple relatively accurate solutions with high fitness, and these solutions are of interest. An acceptable level of accuracy would be a rule that is correct under 90% or more of tested initial conditions. The density-classification problem provides a computationally feasible testing ground for developing a GA with appropriate parameters for the brain CA. The GA should show convergence on suitable solutions within a reasonable number of iterations (e.g. 5000 iterations). An inability to converge on high fitness solutions would indicate that GA parameters need to be altered. Solutions with relatively high fitness should be able to activate the default mode nodes while inactivating other nodes. Solutions with high fitness that do not result in this behavior indicate a poorly defined fitness function.

In some embodiments, a failure to find a set of CA parameters that can reproduce resting state activity within a reasonable level of accuracy may result from several factors. Combining all positive or negative neighbors into aggregate positive or negative neighbors may be an overly reductionistic model of the functional network topology. A possible solution is to increase the neighborhood to include nodes that are two edges away from a node of interest. In a social network, these would be friends of a friend. A 7-bit neighborhood could be used that would store four supplementary bits in addition to the direct positive neighbors, direct negative neighbors, and self stored in the 3-bit neighborhood. These four additional bits are indirect negative neighbors connected to direct negative neighbors, indirect negative neighbors connected to direct positive neighbors, indirect positive neighbors connected to direct positive neighbors, and indirect negative neighbors connected to direct positive neighbors. This larger neighborhood size may more effectively transmit information throughout the system.

Furthermore, possibly the most important component of the GA is the fitness function. If this is not defined correctly, the desirable characteristics of the system may not be captured. Examining plots of the fitness of individuals may reveal flaws that can be corrected in alternative fitness functions. A potential alteration to the fitness function is to take into account the variability of the CA output in the final time steps. A chromosome with relatively high fitness, as it is defined above, but high variability is not as desirable as one with slightly lower fitness but very low variability. Another alternative is to examine the frequency spectrum of the fitness over the final steps of the CA. The frequency components of the fitness function may indicate motifs of signal travelling through the system. For example, the DMN nodes may be turning on once every 10 time steps, and this may be reflected in a frequency component at 0.1 Hz (if 1 time step equates to 1 second).

Finally, it is noted that the GA parameters obtained from the density-classification problem may not be ideal for replicating resting state behavior, and it is recognized that these values may need some alterations.

Spatial Distribution of High Centrality Nodes in Resting State Networks

Initial investigations into leverage centrality have focused on examining the spatial distribution of high centrality nodes throughout the resting state brain.

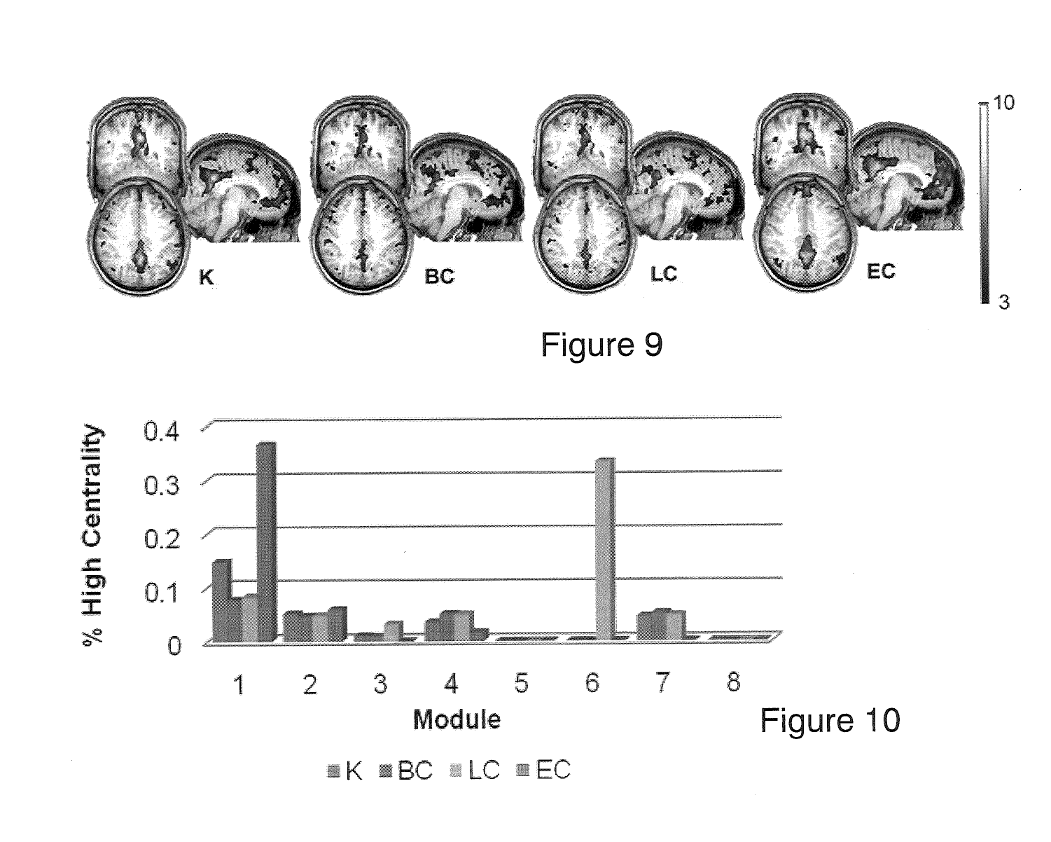

Degree, betweenness, leverage, and eigenvector centrality were calculated for 10 subjects at rest using data collected in an independent study. In each subject the highest 20% centrality nodes for each centrality were identified and overlap maps were created, summarizing the consistency in the spatial location of high centrality nodes according to each centrality metric across subjects (FIG. 9).

FIG. 9 demonstrates that there are regions in the resting functional brain network that are consistently central to the network topology. These are regions that are known to be highly active during resting state[61]. There are certainly many regions with high centrality according to all centrality metrics, but receiver operating characteristic curves to assess the ability to identify hubs revealed that leverage had the highest sensitivity and specificity out of the four metrics. The role of high leverage centrality nodes from two additional perspectives and the ability of information to flow through the network and the modular structure of the network may be investigated.

Spatial Distribution of High Centrality Nodes Across Modules

The spatial distribution of high leverage nodes across network modules may be studied. It is believed that high leverage nodes play an important role in module organization, so an initial step was to determine whether high leverage nodes are present in all modules. Leverage, degree, betweenness, and eigenvector centrality were calculated at each node of a network generated from the resting-state network of a representative subject. For this subject the highest 20% centrality nodes for each type of centrality was identified. The network was then decomposed into modules, and the percentage of high centrality nodes located in each module was calculated. The results are shown in FIG. 10. High leverage nodes were present in more modules than the other centrality types, providing some indication that high leverage nodes are more distributed across modules. Interestingly, module 6 had no high degree, betweenness, or eigenvector centrality nodes, but showed a pronounced presence of high leverage nodes. Replication of these findings in additional subjects may be an important step.

Modeling the Resting State Brain Network Using a 1D CA

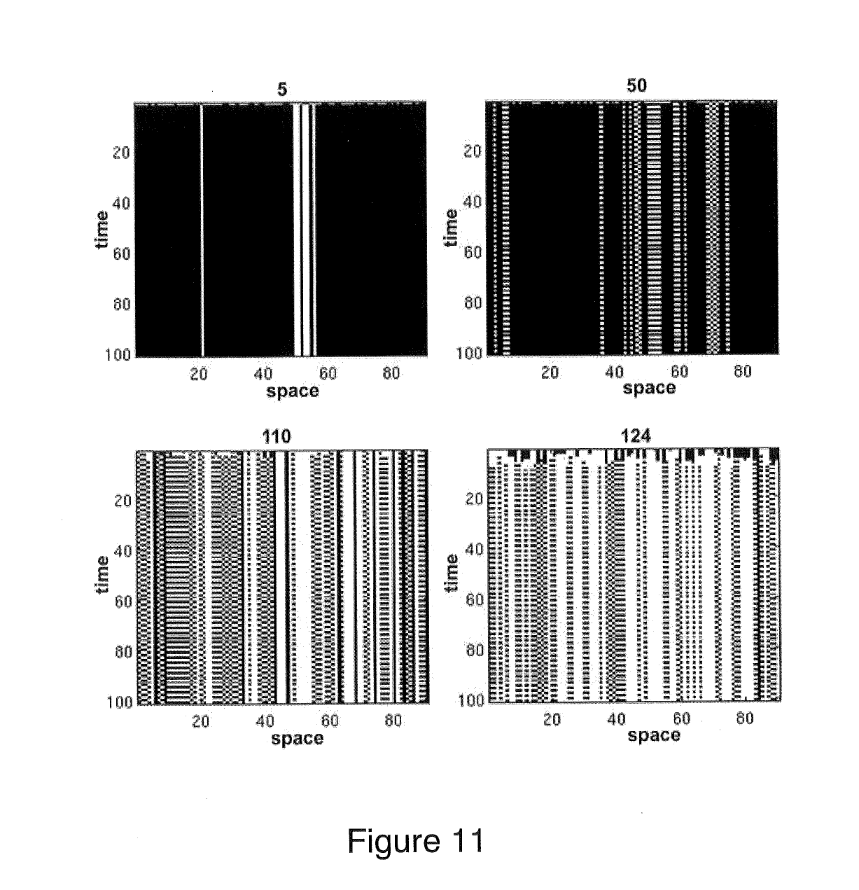

A 1-dimensional CA has been constructed as described in section C.2 in Research Design and Methods. The space-time diagrams generated from four 8-bit rules are shown in FIG. 11 below The four rules shown are four of Wolfram's coded rules—rules corresponding to the 8 possible states shown in Table 1. The name of the rules correspond to the decimal conversion from their binary strings. For example, recall that Rule 110 was 01101110, which in decimal form converts to 110. All rules were tested under randomly generated initial configurations of on and off nodes. Positive links with correlation values greater than 0.3 and negative links with correlation values less than −0.2 were included in the network. At least 60% of positive neighbors or 60% of negative neighbors needed to be in the on state for the positive or negative neighbor bits to be 1. In each case, a few iterations pass before the system settles into a steady state. The steady state attained using rule 5 is constant, but in the other three cases the steady state is oscillatory. Although only 100 iterations are shown here, this oscillatory behavior has been demonstrated in simultions running to 5000 time steps. Because of the high potential for a rule to result in oscillatory behavior, it may be important to consider the last several time steps at the end of the CA run when evaluating fitness.

Solving the Density-Classification Problem in a 1D Elementary CA

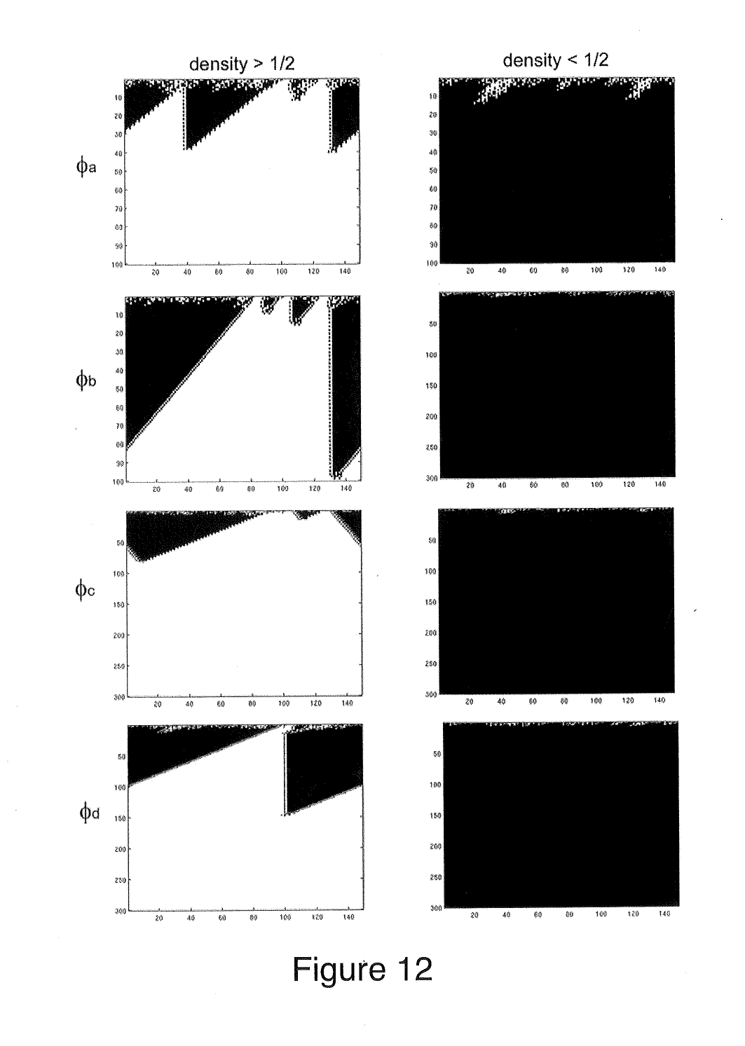

The previously described density-classification problem was replicated in a 1-dimensional elementary CA including 149 cells. Calculations used to solve this problem is described in Mitchell M (1998) An Introduction to Genetic Algorithms. Cambridge: MIT Press. The GA began with an initial population size of 100 chromosomes, which includes 128-bit rules. In this case, the rule is 128 bits, as opposed to 8 bits as in the brain CA, since the neighborhood size considered is 7 (i.e. the 3 left-hand neighbors, self, and the 3 right-hand neighbors). Each rule was tested on 100 unique initial configurations of the CA, and the CA was run for 300 iterations for each individual. Fitness was evaluated based on the fraction of initial configurations in which the rule produced the correct final output state. The top 20 chromosomes were selected for crossover, where parents were selected with uniform probability until the original population size was obtained. Each offspring was mutated at two locations selected at random, and no mutation was performed on parents. After 100 generations, the top six rules all had a fitness of 95%. Initial configurations in which these rules failed typically had densities very close to 50%, which is the most difficult classification to make correctly. Interestingly, most successful rules were relatively young and had existed in the simulation for only 1 or 2 generations, although the previous generations also had many high-performing individuals. This seems to indicate that calculation was settling on a maximum over the last several generations. Shown in FIG. 12 are the results of four of the top rules (labeled φₐ−φ_{d}), given initial configurations where the density was greater than ½ (left column) or less than ½ (right column). This simulation utilized the parallel computing toolbox in Matlab, which enabled simultaneous evaluation of multiple initial configurations for each chromosome. The time to process one chromosome under all initial configurations was approximately 20 seconds.

### CONCLUSION

Two approaches to the understanding of the functional brain as a network may be taken. The first investigates the role of highly central nodes in both information transfer through the brain network and also in local modular organization. It has been shown that there are certain regions of the brain that are highly central in terms of the network topology, and that leverage centrality is able to identify these regions with a high level of accuracy. It is a reasonable extension that these nodes may also play crucial roles in the flow of information through the brain. Furthermore, preliminary results suggest that high leverage nodes are more distributed across network modules, which is in support of the hypothesis that these high leverage nodes are structurally important to modular organization. The second utilizes agent based models as an approach to modeling the complex behaviors in the brain. A methodology for the design of a cellular automaton is in place, including the process of collapsing the multi-dimensional brain network into a 1-dimensional CA and the process of determining the parameters for that CA. Both of these approaches utilize network-based modeling, the advantage of which is that the brain can be treated as an integrated system such that both local interactions and global emergent behavior can be considered simultaneously. A better understanding of how these low level interactions can produce complex behaviors in the brain, and the identification of regions that are most central to those behaviors may be achieved. A model of the healthy human brain is a valuable step, and additional models may include other behaviors, states, and diseases.

Agent-Based Brain Model

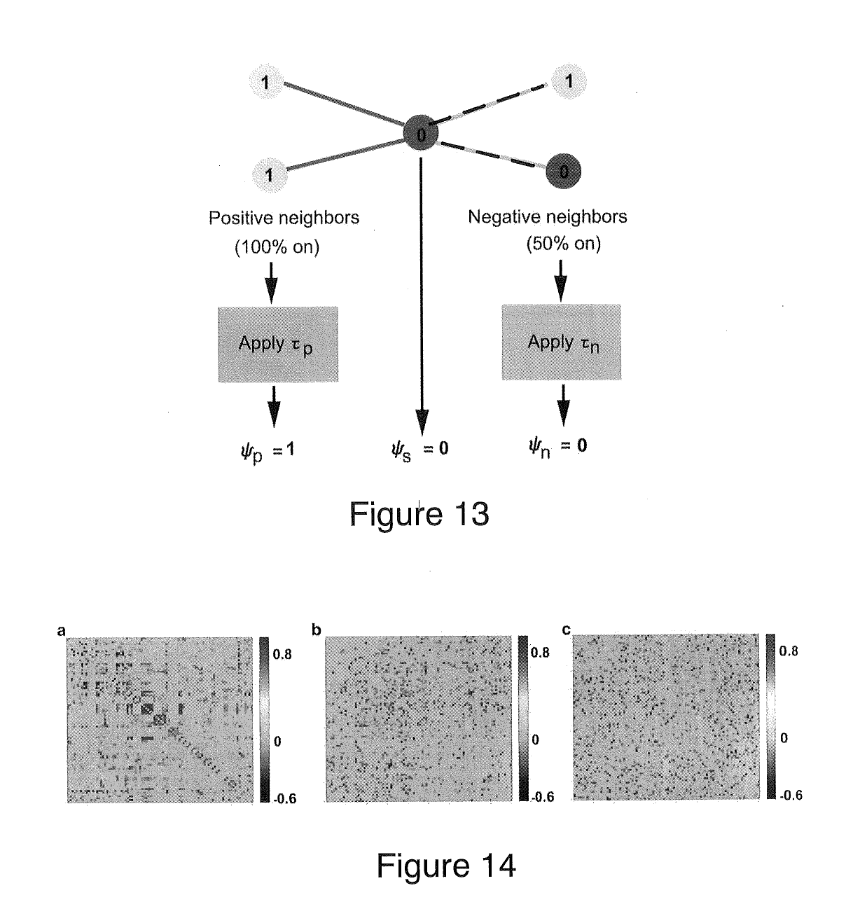

In some embodiments, an agent-based brain model (ABBM) may be used to perform calculations and/or interact with an environment, for example, as described in FIGS. 1A-1D. For example, an exemplary agent based model was created as shown in FIG. 3. The agent based model is represented by the 90 nodes of the brain network, and links represent communication pathways between the agents. In order to succinctly visualize the output of the ABBM by representing the brain model as a cellular automaton (CA), the 90 nodes of the brain network may be arranged on a 1-D grid. Each node has a state, which may be on (active) or off (inactive), and the states update over successive time steps based on the states of connected neighbors. As states update, the new 1-D grid is printed directly below the original one. All nodes are assigned an initial configuration at the start of the simulation, and all nodes are updated simultaneously. A 3-bit neighborhood is defined for each node based on its current state and the states of the immediate neighbors (FIG. 13). These three bits are the positive bit ψₚ, self bit ψₛ, and negative bit ψₙ. The self bit is simply the state of the node itself, and can be either 1 (on) or 0 (off). The positive bit is based on the weighted average of states of all neighbors that are connected by positively-valued correlation links, with correlation coefficients as weights. If this weighted average exceeds some threshold, τₚ, then the positive bit, ψₚ, is set to 1. Similarly, the state of the negative bit ψₙ is based on the weighted average of states of all negatively connected neighbors of the node. The state of the negative bit ψₙ is then determined by applying the threshold τₙ. These thresholds may be user-defined, or chosen using an optimization algorithm (see section 2.3 on solving test problems with genetic algorithms). An example of the process of determining the neighborhood of a given node is pictured in FIG. 13.

As illustrated in FIG. 13, the neighborhood for an example node (center node) is shown. “Neighbors” refers to adjacent or linked nodes. The lines on the left (solid lines) connecting to the “1” nodes indicate positive connections to positive neighbors (two left-most nodes) and the lines on the right (dashed) indicate negative connections to negative neighbors (two right-most nodes). Nodes are either on (nodes with values of 1) or off (nodes with values of 0). Thresholds are applied to the percentage of positive or negative nodes in the on state to determine the value of those bits in the binary neighborhood. In this example, all links are considered equally weighted, but in the ABBM, link weights may contribute to the percentage of nodes that are on or off.

One intuitive interpretation of the above is that each node receives information from all of its connected neighbors, but the information is weakened if the two nodes are only weakly correlated. Neighbors that are negatively connected are grouped together to form one aggregate negative neighbor. Similarly, neighbors that are positively connected form one aggregate positive neighbor. Given two possible states (on or off) and a 3-bit neighborhood Ψ, 2₃=8 possible neighborhood configurations exist. Those combinations are shown in Table 2, commonly referred to as a rule table. The top row displays the 8 possible neighborhood configurations at the current time t, and the bottom row displays the state that a node having a given configuration will take in the next time step, t+1.

TABLE 2
Rule 110 for a binary neighborhood of size 3.
Neighborhood ψ = [ψ_{p,t} ψ_{s,t} ψ_{n,t}]

| | 111 | 110 | 101 | 100 | 011 | 010 | 001 | 000 |
|---|---|---|---|---|---|---|---|---|
| Next State | 0 | 1 | 1 | 0 | 1 | 1 | 1 | 0 |
| ψₛ,(t + 1) | | | | | | | | |

In order to determine if characteristics particular to the brain network topology drive the behavior of the ABBM, equivalent random networks were generated as null models of the original brain networks. Two null models were created for each brain network. The first null model (null1) was formed by selecting two edges in the correlation matrix and swapped their termini. This method preserved the overall degree of each node without regard to whether connections are positive or negative. The second null model (null2) destroyed the degree distribution by completely randomizing the origin and terminus of each edge in the correlation matrix. FIG. 14 shows an example network and the corresponding null models. Where different realizations of the original network were studied (i.e. fully connected, thresholded, and binary), an equivalent null1, and null2 model was made for each realization.

Evolving Rules to Solve Test Problems

The ABBM was tested on two well-described test problems, namely the density-classification and synchronization problems. These tasks have been used previously to show that a 1-D elementary cellular automation (“CA”) can perform simple computations. See Back, T., Fogel, D., & Michalewicz, Z. (1997), Handbook of Evolutionary Computation, In. Oxford: Oxford University Press. Since the ABBM is based on a functional brain network that has a complex topology, and because nodes are diverse in the number of positive and negative connections, this is not an elementary cellular automaton. Therefore, these tests were performed in the ABBM to show that it too is capable of computation.

The goal of the density-classification problem is to find a rule that can determine whether greater than half of the cells in a CA are initially in the on state. If the majority of nodes are on (i.e. density>50%), then by the final iteration of the CA, all cells should be in the on state. Otherwise, all cells should be turned off. The ABBM should be able to do this from any random initial configuration of on and off nodes. For the synchronization task, the goal is for the CA to synchronously turn all nodes on and then off in alternating time steps. As in the density-classification problem, the CA should be able to perform this task from any random initial configuration. These problems would be trivial in a system with a central controller or other source of knowledge of the state of every node in the system. However, in the ABBM each node receives limited inputs from only a few other nodes in the network. Each node must decide based on this limited information whether to turn on or off in the next time step, resulting in network-wide cooperation without the luxury of network-wide communication.

These problems may be solved by finding an appropriate rule through genetic algorithms (GA). Genetic algorithms exploit the concept of evolution by combining potential solutions to a problem until an optimal solution has been evolved. In general, a GA begins with an initial population of individuals, or chromosomes. These individuals are potential solutions to a given problem, and their suitability is quantified by a fitness function. Typically the fittest individuals, those that produce the highest fitness, survive and reproduce offspring. Each offspring is a new solution resulting from a crossover of the parents' chromosomal materials; each progenitor chromosome consists of components taken from two parents, ideally incorporating desirable characteristics from both. Offspring may be subject to mutations, which diversify the genetic pool and lead to exploration of new regions of the solution space. Mutations that increase the fitness of an individual tend to remain in the population, as they increase the probability that those individuals will survive and reproduce offspring. This process of evaluating fitness, selecting parents, reproducing, and introducing mutations is repeated for a number of generations.

Genetic algorithms were implemented to solve the two test problems as described in Back, T., Fogel, D., & Michalewicz, Z. (1997), Handbook of Evolutionary Computation, Oxford: Oxford University Press with minor modifications to suit the ABBM. For both the density-classification and synchronization problems, the initial population was composed of 100 individuals. Each individual contained 22 binary bits, where bits 1-7 represented the value of τₚ, bits 8-14 represented the value of τₙ, and bits 15-22 represented the 8-bit rule. The initial values for each variable were generated with uniform random probability. At the beginning of each generation, each chromosome was tested on 100 unique initial configurations (system states). These initial configurations were designed to linearly sample the range of densities from 0 to 100%.

The fitness was calculated as the proportion of initial configurations for which the ABBM produced the correct output, and ranged from 0 to 1. The individuals with the top 20 fitness values were selected for crossover. An additional 10 individuals were selected at random from the bottom 80 individuals in order to increase exploration of the solution space. These 30 individuals were saved for the next generation, and the remaining 70 individuals were generated by performing single-point crossover within each variable. Each offspring was mutated at three randomly selected points, where the bit is reversed from 0 to 1 or 1 to 0. The genetic algorithm was iterated for 100 generations. To avoid convergence on a poor solution, the mutation rate was increased when the mean hamming distance of the population was below 0.25 and the fitness was less than 0.9. In such cases, the mutation rate was randomly increased to 4-22 bits per chromosome. These changes to the genetic algorithm increased the average maximal fitness level from about 0.65 to about 0.85.

Behavior of ABBM

The behavior of the agent based brain model is governed by an 8-bit rule and the parameters τₚ and τₙ, the positive and negative percent thresholds. The effects of these factors on output patterns of the ABBM were investigated.

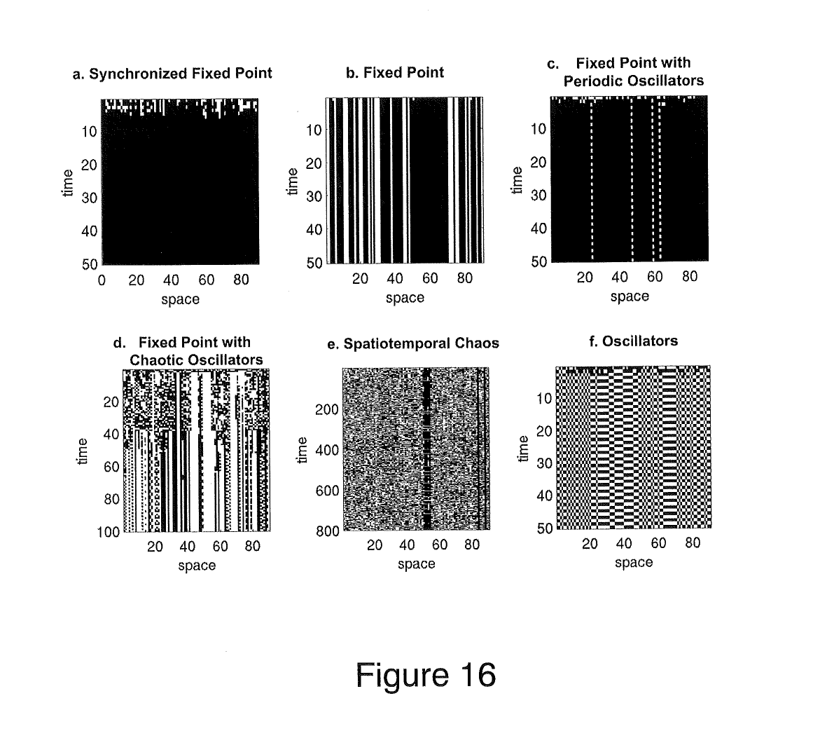

The spatial arrangement of cells in the space-time diagrams does not reflect the configuration of nodes in the network, as each node shares connections with other nodes that may be located anywhere in the brain network. As such, the spatial patterns that have historically been used to classify elementary cellular automata may not apply here. Instead, a classification scheme was used including the following: synchronized fixed point, fixed point with periodic orbit, fixed point with chaotic orbit, spatiotemporal chaos, fixed point, and oscillators. These classifications are shown in FIG. 16.

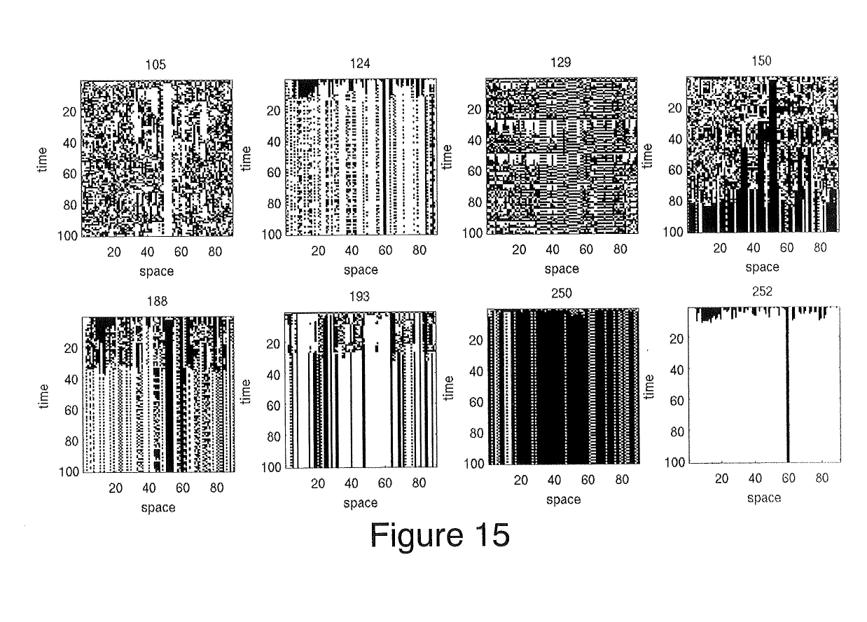

Output patterns are visualized as space-time diagrams, in which nodes are represented horizontally as columns consisting of white (on) or black (off) squares, and each time step is shown as a new row appended below the previous one. Rule diagrams were generated, showing output of the ABBM for rules 0 through 255, starting from the same initial configuration of 30 randomly selected nodes being on, and at fixed values of τₚ and τₙ. A selection of rules is shown in FIG. 15. Each rule started from the same initial configuration in which 30 randomly selected nodes were turned on. The threshold parameters τₚ and τₙ were both set to 0.5. The ABBM may be capable of producing a diverse range of behaviors depending on the rule (e.g., an 8-bit rule specified).

With reference to FIG. 15, a synchronized fixed point is shown in panel a, where all nodes take the same state. In panel b, the ABBM is in the fixed point phase, where nodes can be either on or off, but do not change in subsequent time steps. In panel c, steady state is reached after a few time steps and is characterized by fixed point nodes with some nodes perpetually oscillating between states. Fixed point with chaotic oscillators is shown in panel d, in which the system undergoes an extended period of state changes with no obvious pattern, until steady state is eventually reached. Panel e depicts spatiotemporal chaos, in which the system may continue for hundreds of thousands of steps without repeating states, until finally steady state is reached. Finally, panel f depicts the phase in which all nodes in the system are oscillating between two states.

This classification scheme enables the qualitative description of the output of the ABBM, and also brings two observations to light. First, modifying the underlying ABBM rule modulates the output of the model. Second, the same rule can cause dramatically different behavior depending on the model parameters τₚ and τₙ. This effect was examined by modifying these parameters and observing the output of the model. The model output was quantified using two metrics: the number of steps for the system to reach steady state, which may either be constant or oscillatory, and the period length at the steady state. The outcome metrics may be summarized as color maps where each data point corresponds to an outcome metric value of the ABBM corresponding to the model parameters τₚ and τₙ on x- and y-axes, respectively. Simulations at each point on the color maps began at the same initial configuration of nodes being on or off. It is important to hold the initial configuration constant within each color map as different initial configurations can change the time to reach a steady state as well as the steady state period length (see 3.2 on attractor basins). The number of steps for the ABBM to reach a steady state may be determined, e.g., starting from 5 distinct initial states. The results demonstrate a wide range of behaviors that can be elicited by varying just two model parameters, τₚ, and τₙ. The results for the number of steps for the ABBM to reach a steady state were calculated for one rule, Rule 41, out of the 256 possible 8-bit rules. A wide range of behaviors was observed; however, the overall qualitative properties were fairly consistent across initial configurations. There are distinct regions in which the system takes a few thousand steps to settle, regardless of the initial configuration of the system. The determination was not the same for the null models, providing evidence that the network structure shapes the ABBM behavior.

For the original brain network, there is a concentrated region where the period of the steady state behavior (i.e. the attractor basin into which the system has settled) is very long, and the output landscape is qualitatively consistent across initial configurations. The outputs of the null models are very different from those of the original network. There are no regions exhibiting extremely large periods (in excess of 1000 time steps). While very large periods may be possible in random networks using Rule 41, there are strikingly different results for the brain network versus the null models for the conditions shown here. This further demonstrates that the network structure may be influential for determining the behavior of the ABBM.

Attractor Basins

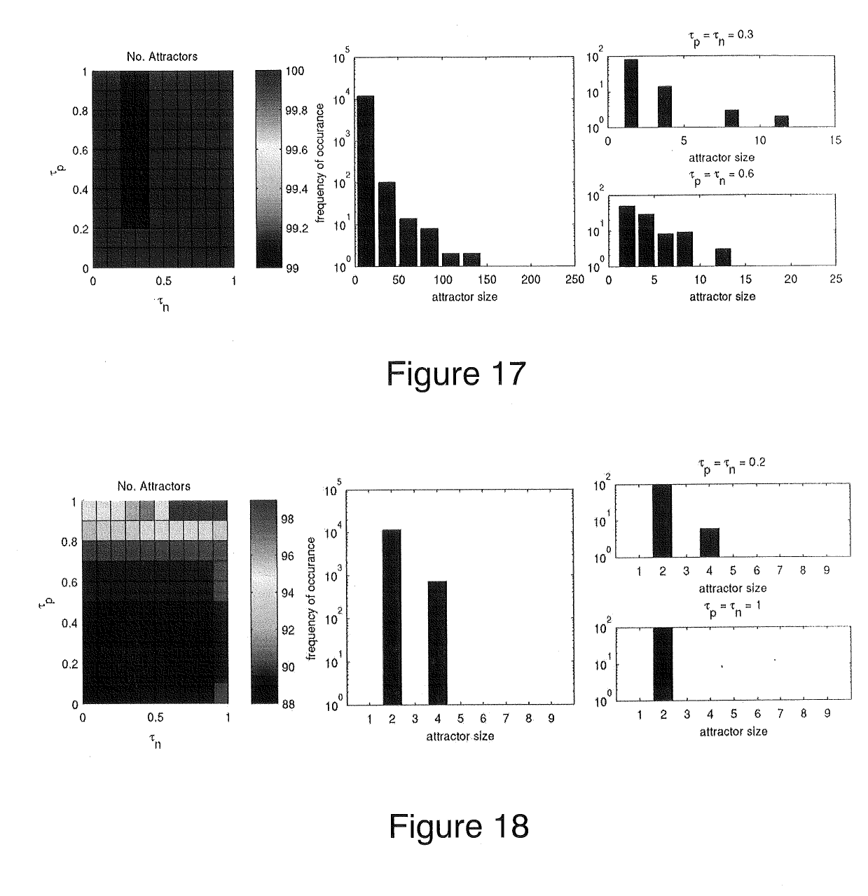

The ABBM was run from 100 different initial configurations and the results are visualized in FIGS. 17-19 for three qualitatively different rules. FIG. 17 shows Rule 198 with long times to settle as well as a concentrated region of large attractor basins. The color map (left) shows the number of unique attractors that were found out of 100 runs at each point in τₚ−τₙ space. At each point, with only a few exceptions, unique initial configurations led to unique attractor basins. The histograms show the frequency of occurrence of attractors sorted by their period lengths for the entirety of τₚ−τₙ space (middle) and for two selected points (right). Interestingly, the frequency of attractor sizes across all of τₚ−τₙ space appears to follow a power law, although only two orders of magnitude are shown. Since the attractor sizes vary greatly, the attractor landscape of Rule 198 is very diverse.

FIG. 18 shows Rule 27, with both short times to settle and short periods. The color map (left) showing the number of unique attractors demonstrates that typically each initial configuration led to a different attractor basin, with only a few repeated attractors. The histograms (center, right) show that these attractors are somewhat homogenous in terms of size. Since Rule 27 consistently has a short settle time and a short period, its attractor landscape may include a very large number of isolated short attractors with just a few states leading to each. This is classified as a very simple rule.

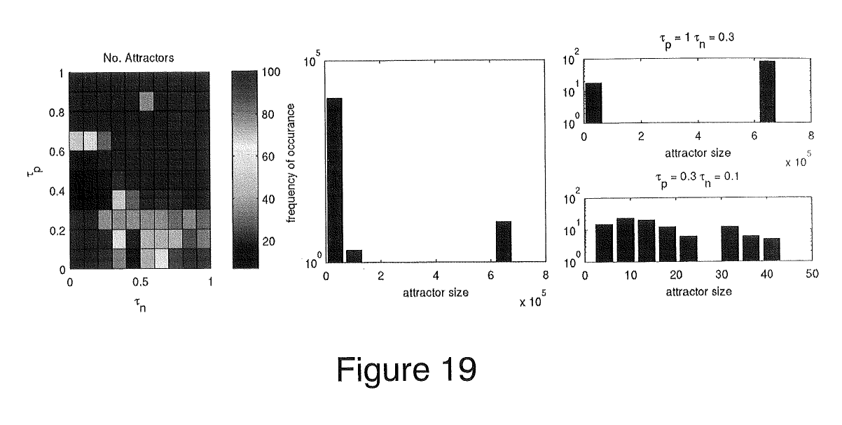

Conversely, Rule 41 (FIG. 19) demonstrated an impressively diverse landscape. The number of unique attractors is highly variable; in some portions of τₚ−τₙ space a different attractor was encountered with each initial configuration, while in other locations the same 10 to 20 attractors occur repeatedly. The two point-of-interest histograms (FIG. 19, right) examine specific locations of τₚ−τₙ space in greater detail. The upper plot was generated from a location where a different attractor was found for each initial configuration. The lower plot was generated from a location that had many occurrences of a particularly large attractor—one having a period of over 680,000 steps. We conclude that Rule 41 is a very complex rule, as it is difficult to predict the type of behavior the system will elicit. We have examined only three rules here, but the color maps included in Supplemental Material 2 are good indicators of the type of attractor basin landscape belonging to each rule. Rules that tend to have rapid settle times and short periods are fairly simple rules, while those that have settle times and period lengths that span many orders of magnitude tend to be complex, meaning that their behavior is very difficult to predict.

Problem-Solving with the ABBM

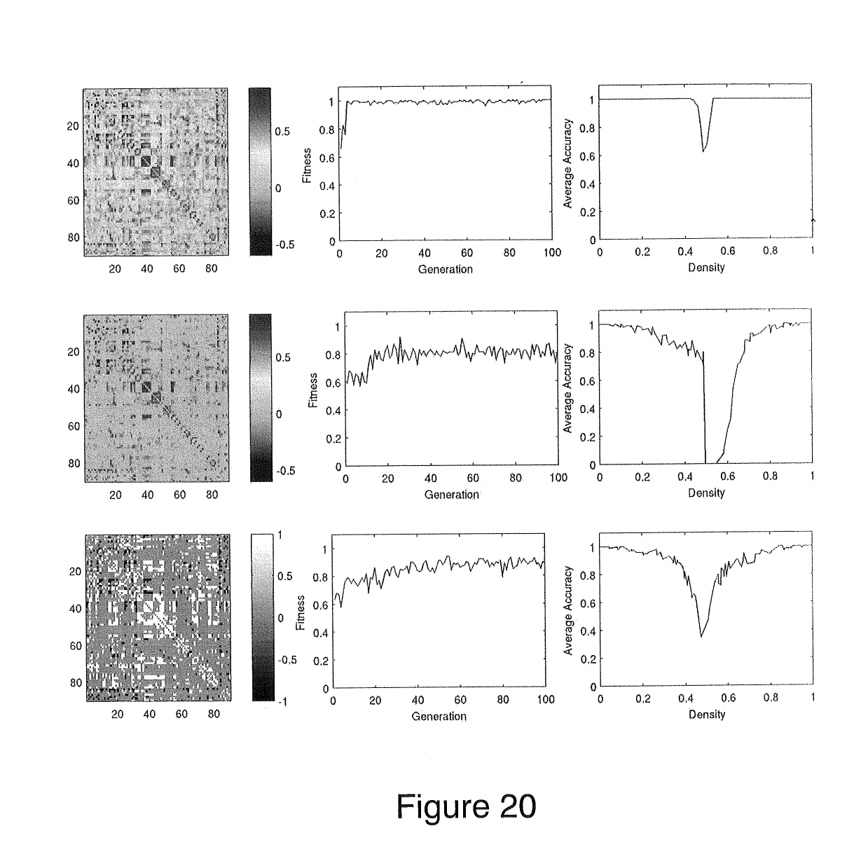

Density classification results for the ABBM are shown in FIG. 20. The genetic algorithm was run using the original fully connected network, the thresholded brain network (thresholded such that the average degree was 21.8), and the binary brain network (derived from the thresholded correlation matrix). Their connectivity matrices are shown in FIG. 20, left. For these networks, an optimal rule and set of parameters were sought using the GA, and their results were compared. FIG. 20 shows the plots of the highest fitness individual in each generation of the GA (middle column) and the performance of the best individual on the density-classification task, quantified by average accuracy (right column).

Using the fully connected network (FIG. 20, first row), the ABBM achieved a fitness value of 1 after just 4 generations. In this network, each node obtains information about all other nodes in the network. Although this information is modulated by the connection strength, each node has global information about the state of the system. Such a network is not solving a global problem using limited local information so it is not surprising that the model was able to solve the density problem with high speed and accuracy. Most naturally occurring networks, including the brain, are sparsely connected and each node only has information from its immediate neighbors. The thresholded brain network (FIG. 20, second row) and the binary network (third row) are more consistent with the connectivity of the brain. In our model, information at each node is limited to 21.8 nodes out of 90 nodes on average, or about 24% of the network.

Furthermore, removing weak links from the network results in groups of nodes that are well interconnected among themselves and less interconnected with the rest of the network, a property known as community structure. Information is shared within a community, and community nodes likely tend to synchronize states with each other more readily than with other network nodes. Therefore one community that is only weakly connected to the rest of the network may not be consistent with the remainder of the network. Consequently fitness is lower, with the thresholded brain network achieving fitness values of approximately 80%, and the binary network achieving maximum values of approximately 87%.

Accuracy curves (FIG. 20, right) are shown for the highest performing individual at the final generation of the GA. These curves plot the percent of correct classifications, averaged over 100 initial configurations, across a range of densities on the x-axis. The trends in accuracy curves follow expectations based on the GA fitness results, with the fully connected network performing the best, followed by the binary network, and finally the thresholded network. In each curve, there is a pronounced dip centered at around 50% density, where classification is most difficult.

There is a notable decrease in fitness and accuracy for the weighted, thresholded network as compared the corresponding binary, thresholded brain network. Without wishing to be bound by any particular theory, this may be due to relatively weak links connecting some modules to the rest of the network. These links may be too weak to convey sufficient information about the rest of the network within our model, causing nodes to behave based largely on limited information. While some links are strong enough to survive the thresholding process, the net signal from multiple weak links may be too weak to allow the signal to exceed the τₚ or τₙ threshold and pass the signal on. The amount of information available to any one node in the system is greatest in the fully connected weighted network since each node receives some degree of information from each other node. When a threshold is applied to the weighted network, many of these connections are removed and the node relies solely on local information, modulated by connection strength. When this network is binarized, the signal is not modulated by connection strength and is therefore more strongly represented. There is currently no consensus on network representation. Proponents of binarized networks argue that neuronal firing is a binary event and therefore binary networks are appropriate models. Proponents of weighted brain networks argue that signal correlations indicate the contribution of each node to the information received by a particular node, and therefore weighted networks are most representative of biological processes. Based on the findings in FIG. 20, the binary representation may be most effective for information processing, as each node receives local information about the system, as is true for individual neurons, and this input is strong enough to provide sufficient information for the decision making processes.

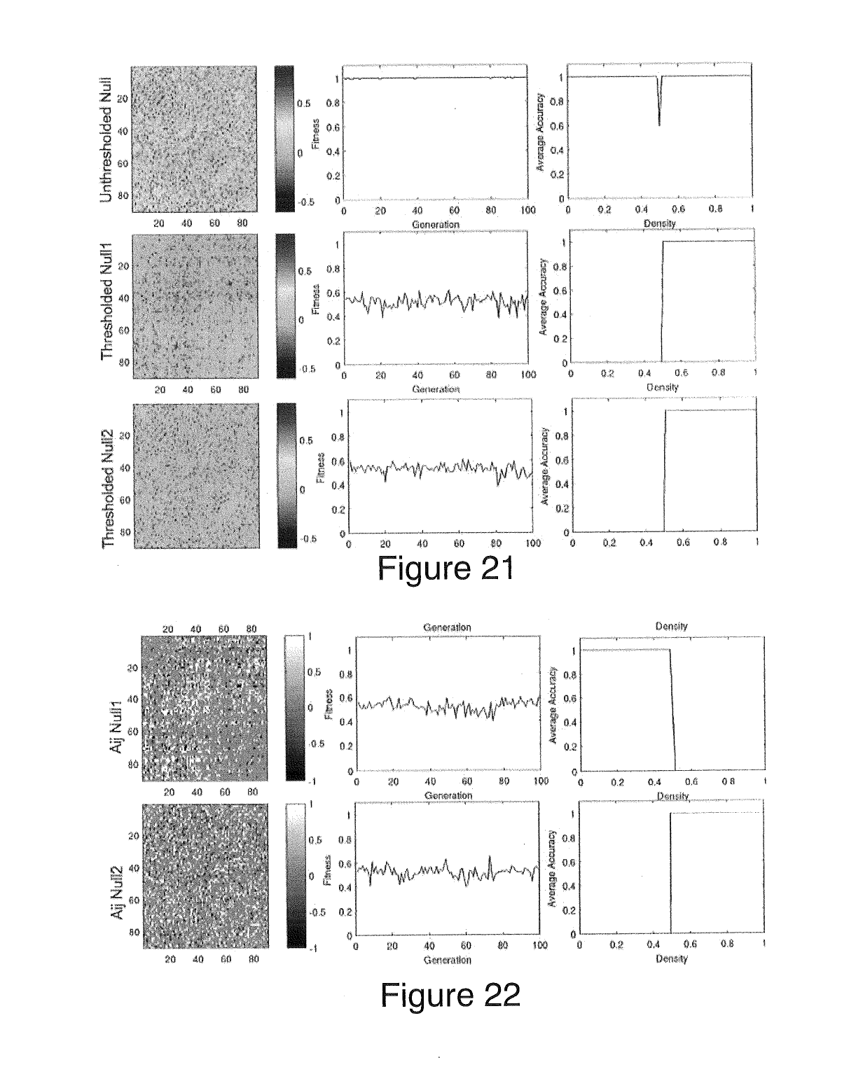

Density classification was also performed using the null networks, (FIG. 21-22) including a fully connected null network, a thresholded null1 and null2 network, and a binary null1 and null2 network. The GA was run on each network as described for the original networks. The fully connected null model was generated by randomly swapping off-diagonal elements of the original correlation matrix, resulting in a network whose connections strengths are random. The thresholded null1 and null2 models were created as described in the methods section. The binarized null models were created from the corresponding thresholded null models by setting links with values greater than zero to 1, and links with values less than zero to −1. As was true in the original networks, the fully connected model performs the best out of all null models because each node receives some degree of information from every other node in the system.

In contrast, the GA was unable to find a rule that was capable of solving the density classification problem for the thresholded and binary null models (FIG. 21-22, rows 2-5). This is true regardless of whether the degree distribution is preserved. The rules evolved by the GA always turn all nodes on or all nodes off. These results indicate that the architecture of the brain network is suited for computation and problem solving, far more so than a random network. The ABBM model parameters used to produce each case in FIGS. 21-22 are shown in Table 3.

TABLE 3
ABBM Parameters for solving the density-classification problem

| | | |
|---|---|---|
| τₚ | τₙ | Rule (binary form) |

Original networks

| | | | |
|---|---|---|---|
| Full Correlation | 0.51 | 0.74 | 250 (11111010) |
| Thresh. Correlation | 0.6 | 0.69 | 250 (11111000) |
| Binary | 0.5 | 0.51 | 248 (11111000) |

Null models

| | | | |
|---|---|---|---|
| Null₂ Full Corr. | 0.49 | 0.29 | 160 (10100000) |
| Null₁ Thresh. Corr. | 0.93 | 0.9 | 93 (01011101) |
| Null₂ Thresh. Corr. | 0.38 | 0.36 | 23 (00010111) |
| Null₁ Binary | 0.87 | 0.48 | 10 (00001010) |
| Null₂ Binary | 1.0 | 0.16 | 37 (00100101) |

Results for the performance of the ABBM on the synchronization task were calculated. Regardless of the type of functional network used, the population achieved maximal fitness values within the first few generations of the GA. The chromosome at the final generation of the GA was able to perform synchronization from any of the tested initial configurations across densities. The same is true for each of the null models. These findings indicate that the synchronization task is a far easier problem for the ABBM than the density-classification problem. In order to solve the synchronization task, the ABBM may first turn all nodes either on or off, and then alternate between all nodes being on and all off. The first and last bit of the rule encodes this alternating behavior, and the middle 6 bits encode the process of getting to one of those two states, with either all on or all off being acceptable regardless of initial density. Thus the encoding in the middle 6 bits may be somewhat flexible. On the other hand, in the density-classification task the ABBM must decide whether to turn all nodes on or all nodes off based on the initial state. This more challenging task requires not only memory of the initial configuration, but communication of the global past configuration to all nodes in the system.

A new dynamic brain model is provided that is based on network data constructed from biological information, as well as an expanded classification scheme for model output. Time-space diagrams and color maps characterize the behavior of the model depending on the rule and parameter values. The results presented here demonstrate that the model is capable of producing a wide variety of behavior depending on model inputs. This behavior is largely driven by the rule and location in τₚ-τₙ space, but is qualitatively consistent across initial configurations. The attractor basin landscape was examined, and the time to settle and period may be considered good indicators of the type of attractor basin landscape for to each rule. Rules that have settle times and period lengths that span many orders of magnitude tend to have very diverse attractor landscapes, and their behavior is difficult to predict. Finally, the density-classification problem and synchronization problem were solved. One finding was that the brain network was far more successful in solving density problems than any of the equivalent null models studied. The ability to solve these tasks demonstrates that the network architecture is amenable to problem solving and the model can support computation. While these were simply test problems, they served to exemplify that among all the behaviors that can be produced, some are computationally useful.

The ABBM may be distinct from typical applications of artificial neural networks, where the architecture is engineering with a particular problem in mind and therefore these systems typically do not have a biologically relevant structure. The agent-based brain model utilizes brain connectivity information constructed from human brain imaging data. The model uses basic knowledge of how the brain works at the neuronal level, but applies this knowledge on the macro-scale level. Since the network structure is based on actual human brain networks, the system dynamics are specific to that architecture.

In widely-used equation based modeling techniques, such as modeling of a disease epidemic or a population dynamics in a particular ecosystem, partial differential equations are used to model the behavior of each constituent of the system. On the other hand, in the ABBM, only a set of simple rule is defined for each agent constituting the system, and the behavior of the system over time is observed by allowing the agents to interact with each other. Aside from the rules each agent follows, agents' interactions are constrained only by the underlying brain network structure to model the macro-scale interaction among various brain areas. Simply changing the rule or varying model parameters slightly can result in dramatic changes in the system behavior, from simple synchronization to spatio-temporal chaos.

Genetic algorithms were paired with the agent-based model framework to find a rule and optimized parameters to drive the model. The application of genetic algorithms to the brain network promotes the emergence of behaviors rather than relying on previously learned or programmed responses to specific stimuli. This allows the ABBM to adapt to new and unlearned problems. The parameters determined by the genetic algorithm drive the ABBM to a particular type of attractor basin. Given a properly defined fitness function, genetic algorithms (or other search optimization techniques) may be used to find a rule and set of parameters that will drive the ABBM to attractor basins corresponding to functionally relevant states. For example, the model may be able to produce an attractor basin resembling typical brain activity patterns during rest or under sensory stimulation. A dynamic model that produces biologically relevant behavior would be useful among a range of neurological and artificial intelligence research areas.

As it is presented here, the model utilizes a 90-node functional brain network, but any type of network can be used (functional or structural, directed or undirected, weighted or unweighted, and generated from any task). The ABBM could be applied to networks generated with alternate parcellation schemes or voxel-wise networks. Additionally, although directly connected neighbors were considered here, an alternate form may include neighbors separated by 2, 3, or n steps in the form of a larger neighborhood size.

ABBM Dynamics when Topology is Altered.

The following examples demonstrate that the ABBM dynamics change when the topology of the functional network is altered. Network topology changes may occur after the loss of function of a region due to injury or disease. The topology may also change after strengthening of the white matter connections due to therapy such as transcranial magnetic stimulation. These physiological changes impact the network topology, which in turn impact the network dynamics simulated using the ABBM.

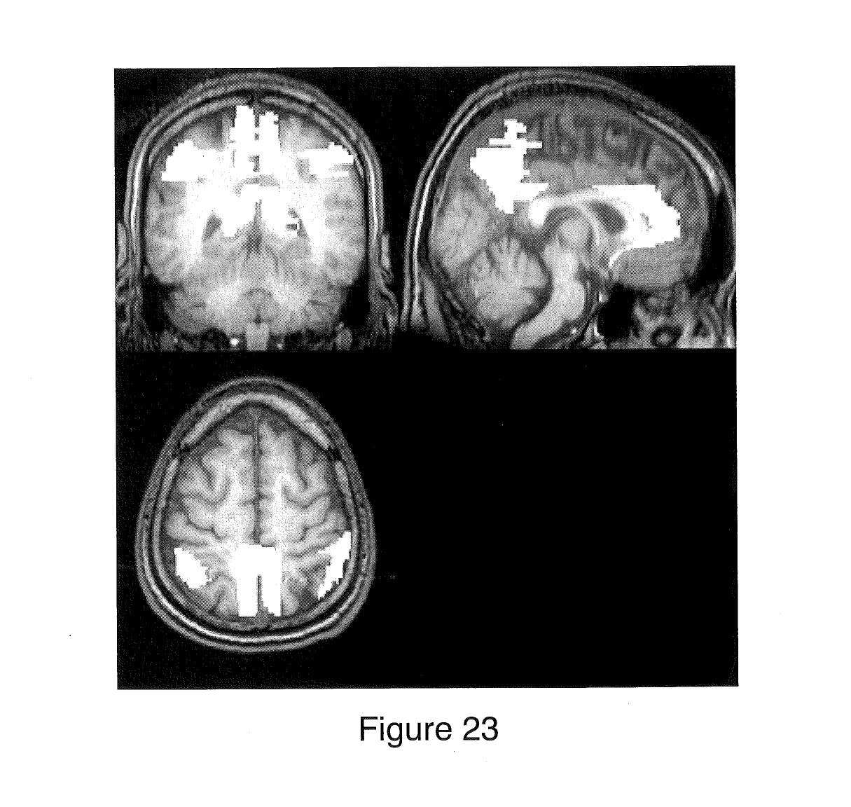

The default mode network is a collection of regions of the brain that are active even when a person is at rest. These eight regions, shown in FIG. 23, are the bilateral (i.e. left and right) anterior cingulate, posterior cingulate, inferior parietal, and precuneus. These examples alter the functional network connectivity of the nodes representing the anterior cingulate cortex (ACC). The white areas indicate regions of interest that are considered to be part of the default mode network.

To run the ABBM, five basic inputs are needed: the network, the rule, the positive bit threshold, the negative bit threshold, and the initial configuration. These inputs are described in previous ABBM documentation, such as the paper in review “Complexity in an Agent Based Brain Model.”

1. The network. For all simulations, the network input to the model was a thresholded weighted network constructed using fMRI data, and consisted of 90 ROI nodes. Positive links with weights between 0 and 0.3916 were removed, and negative links with weights between 0 and −0.1839 were removed. The resulting network is a single component, i.e. there are no disconnected regions.

2. The rule. The rule used for all examples is Wolfram's Rule 230, the rule table for which is below. Recall from previous documentation that the rule table dictates what the state of a node with a certain neighborhood will be in the next time step. This neighborhood is constructed based on the positive bit (determined by applying the positive bit threshold), the state of the node itself, and the negative bit (determined by applying the negative bit threshold).

| | Neighborhood | | | | | | | |
|---|---|---|---|---|---|---|---|---|
| | 111 | 110 | 101 | 100 | 011 | 010 | 001 | 000 |
| Next state | 1 | 1 | 1 | 0 | 0 | 1 | 1 | 0 |

3. The positive bit threshold τₚ was set to 0.3. This means that the weighted average of all positive inputs to a node must be at least 0.3 (scaled between 0 and 1) in order for the positive bit to be a 1.

4. The negative bit threshold τₙ was set to 0.3. This means that the weighted average of all negative inputs to a node must be at least 0.3 (scaled between 0 and 1) in order for the negative bit to be a 1.

5. The initial configuration. The initial configuration was such that the 8 DMN nodes were initially in the on state (1) and all non-DMN nodes were in the off state (0).

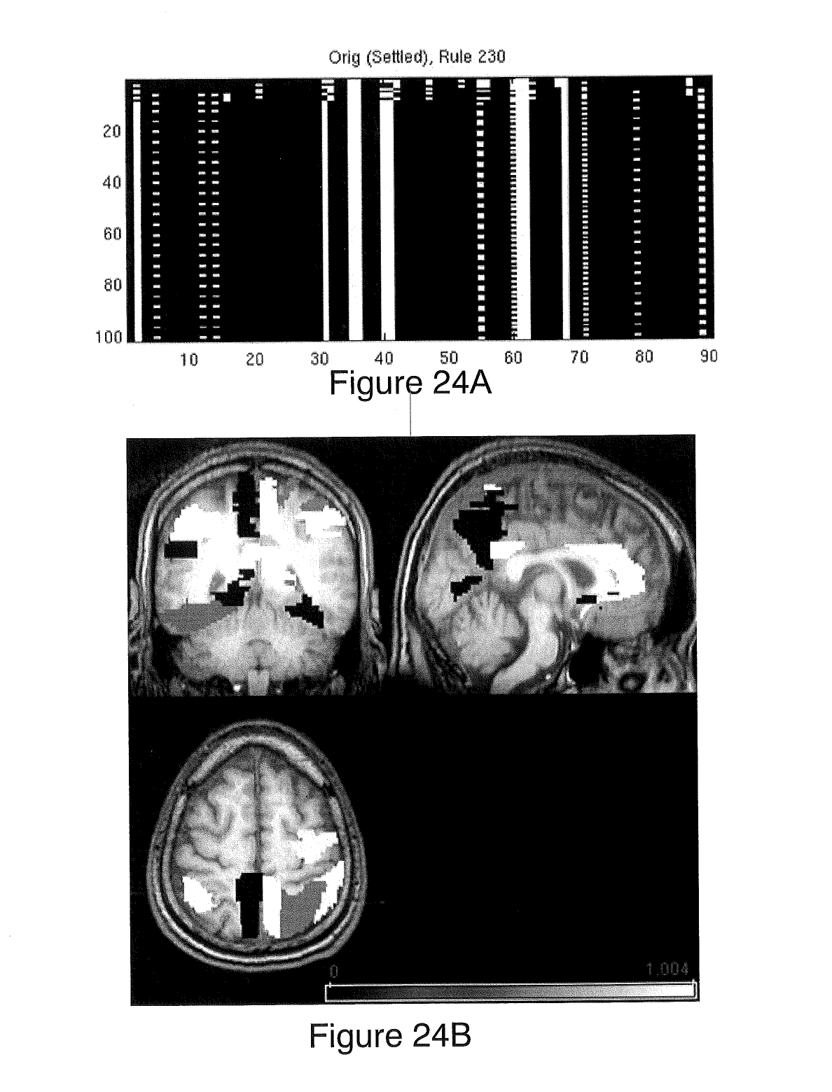

FIG. 24A shows the time-space diagram generated using this 90-node ROI network, Rule 230, and τₚ=τₙ=0.3, of the original network with DMN nodes initially on. Arrows indicate the DMN nodes. FIG. 24B shows the average activity of each ROI in brain space. This was computed by taking the average of the time-space diagram across the time dimension. The DMN nodes are nodes numbered 31, 32, 35, 36, 61, 62, 67, and 68 in the time-space diagram of FIG. 24A. Many of the DMN nodes are active, but many non-DMN nodes are also producing some activity. This demonstrates the transfer of information between DMN nodes, which were initially the only nodes on, and non-DMN nodes, which were initially all off.

Assaulting the 2 ACC Nodes.

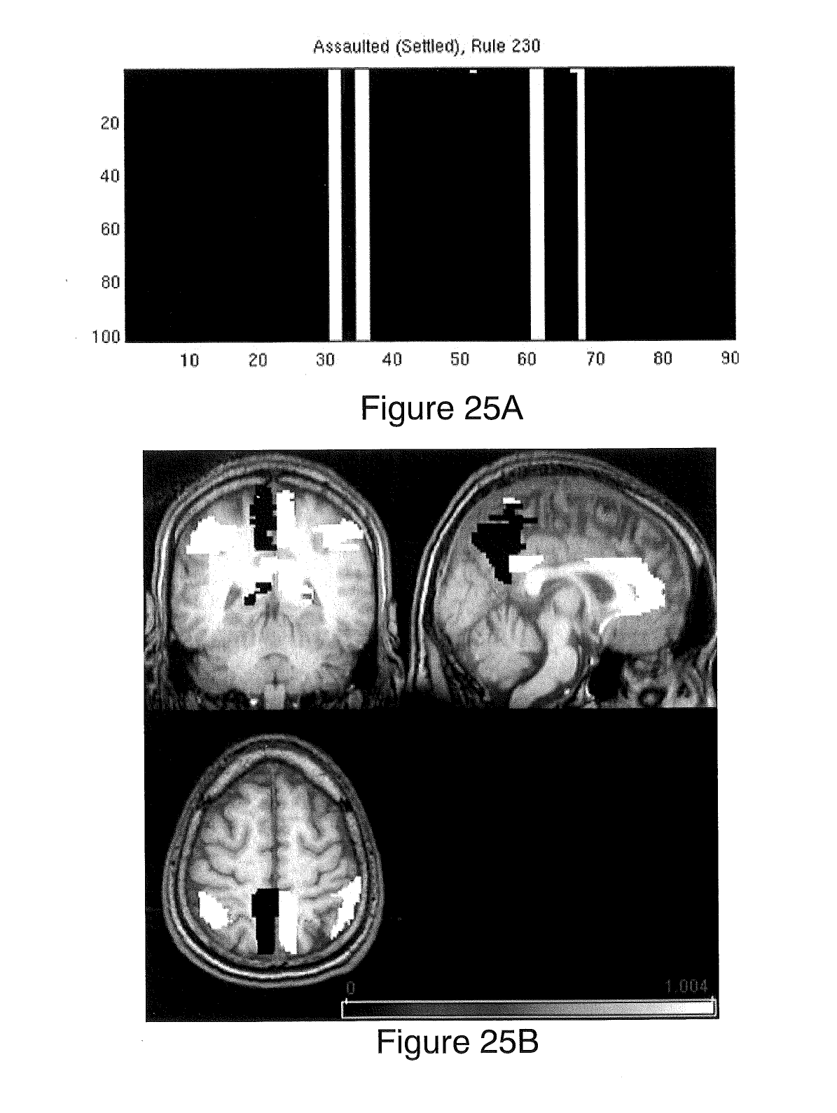

For this first example, all of the links from the ACC to the rest of the network were removed. This altered network was used in the ABBM, but with the same rule (Wolfram's Rule 230), positive bit threshold (0.3), negative bit threshold (0.3), and initial configuration (only the DMN nodes were on) as in the original simulation (FIGS. 24A-24B). The time-space diagram resulting from using an assaulted network is shown in FIG. 25A and the average activity in brain space is shown in FIG. 25B. The ACC nodes were DMN nodes 31 and 32. After removing the links from the ACC nodes, the communication between DMN nodes and non-DMN nodes appears to be drastically diminished. Removing just the ACC links greatly impacted the ability of the DMN nodes to impact the rest of the network. This reduced connectivity has greatly impacted the ABBM dynamics.

Strengthening the ACC Nodes

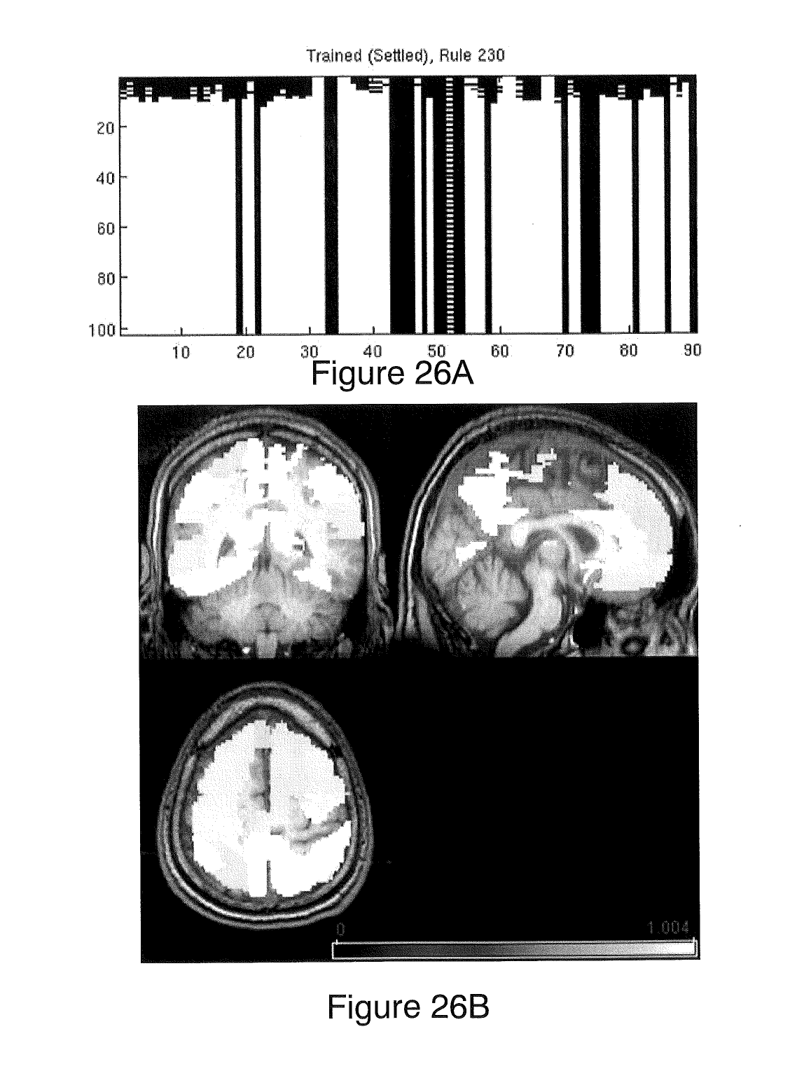

In this example, the connectivity between the ACC nodes and the rest of the DMN nodes are increased. The connections between the ACC nodes and other DMN nodes have been set to 1. This altered network was used in the ABBM, but with the same rule (Wolfram's Rule 230), positive bit threshold (0.3), negative bit threshold (0.3), and initial configuration (only the DMN nodes were on) as in the original simulation (FIGS. 24A-24B). The time-space diagram resulting from using this strengthened network is shown in FIG. 26A and the average activity in brain space is shown in FIG. 26B. This change in topology is reflected in the altered dynamics. Strengthening the ACC node connections to the rest of the DMN nodes enable the information in the DMN to spread to the rest of the network to a much greater extent than in the original simulation.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An agent-based modeling system for predicting and/or analyzing brain behavior, the system comprising:
a computer processor configured to define:
nodes and edges that interconnect said nodes, wherein said edges are defined by physiological interactions and/or anatomical connections; and
rules and/or model parameters that define a functional behavior of said nodes and edges;
wherein the computer processor assigns said nodes to respective brain regions, and said rules and/or model parameters are defined by observed physiological interaction of said nodes that are functionally and/or structurally connected by said edges of brain regions to thereby provide an agent-based brain model (ABBM) for predicting and/or analyzing brain behavior.

2. The agent-based modeling system of claim 1, wherein said rules and/or model parameters are determined by evolutionary algorithms.

3. The agent-based modeling system of claim 1, wherein said rules and/or model parameters are determined by genetic algorithms.

4. The agent-based modeling system of claim 1, wherein said edges are observed by an imaging modality.

5. The agent-based modeling system of claim 4, wherein said imaging modality is a structural MRI, functional MRI, EEG and/or MEG imaging modality.

6. The agent-based modeling system of claim 1, wherein said edges are observed by dissection.

7. The agent-based modeling system of claim 1, wherein the brain regions are mammalian brain regions.

8. The agent-based modeling system of claim 1, wherein said computer processor assigns each of said nodes a state and updates said states responsive to said rules and/or model parameters.

9. The agent-based modeling system of claim 8, wherein computer processor updates said states using model parameters that are task and/or problem-based model parameters.

10. The agent-based modeling system of claim 9, wherein the model parameters are determined by optimization calculations including evolutionary algorithms, simulated annealing and/or hill climbing calculations.

11. The agent-based modeling system of claim 8, wherein said computer processor updates said states using the model parameters so as to model emergent cognition, thought, consciousness, mimic human behavior and/or perform a task.

12. The agent-based modeling system of claim 1, wherein said observed physiological interaction of said nodes that are functionally and/or structurally connected by said edges of brain regions are for a patient, said computer processor is further configured to provide a possible diagnoses for neurological diseases and/or conditions responsive to said nodes, edges, rules and/or model parameters for the patient.

13. The agent-based modeling system of claim 12, wherein said computer processor is further configured to determine a predicted prognosis for neurological diseases and/or conditions responsive to said nodes, edges, rules and/or model parameters for the patient.

14. The agent-based modeling system of claim 11, wherein said computer processor is further configured to perform treatment tests that modify the model parameters and/or agent-based brain model based on a desired treatment and to determine a likely outcome of the desired treatment responsive to resulting changes in agent-based brain model outcomes.

15. The agent-based modeling system of claim 1, wherein said edges comprise a weighting factor corresponding to a strength of interconnectivity between nodes.

16. The agent-based modeling system of claim 1, wherein said nodes comprise a pair of first and second nodes, said first node having a first state with a first state value and said second node having second state with a second state value, and said edges define a positive interconnectivity between said pair of first and second nodes when said first state value and said second state value of the first and second nodes are the same, and said edges define a negative interconnectivity between said pair of first and second nodes when said first state value and said second state value are different.

17. The agent-based modeling system of claim 1, wherein said rules and/or model parameters include an internal motivation curve and environmental opportunity curve.

18. The agent-based modeling system of claim 17, wherein said computer processor is configured to output a behavior responsive to the internal motivation and environmental opportunity curves.

19. The agent-based modeling system of claim 18, wherein said computer processor is configured to modify said internal motivation and environmental opportunity curves responsive to said behavior.

20. The agent-based modeling system of claim 17, wherein said internal motivation curve comprises a measurement of an internal need to perform a behavior or potential behavior, and said environmental opportunity curve comprises a measurement of an availability of a behavior, potential behavior, resource and/or other action, and wherein said internal motivation and environmental opportunity curves together define a benefit for performing each of a plurality of possible behaviors.

21. The agent-based modeling system of claim 17, wherein said functional behavior comprises a plurality of behaviors, each of said plurality of behaviors comprising a weighted benefit corresponding to said internal motivation curve.

22. The agent-based modeling system of claim 19, wherein a modification to said internal motivation and environmental opportunity curves defines said edges that interconnect said nodes.

23. A method for providing an agent-based brain model for predicting and/or analyzing brain behavior, the agent-based brain model comprising nodes and edges that interconnect said nodes, rules and/or model parameters that define a functional behavior of said nodes and edges, the method comprising:
observing physiological interactions of ones of said nodes that are connected by respective ones of said edges;
assigning, by a computer processor, said nodes to respective brain regions;
defining, by a computer processor, said edges responsive to physiological interactions and/or anatomical connections;
defining said rules and/or model parameters responsive to the observed physiological interactions and/or anatomical connections of the brain regions connected by said edges to thereby provide an agent-based brain model; and
predicting and/or analyzing brain behavior using said agent-based brain model.

24. A computer program product for providing an agent-based brain model predicting and/or analyzing brain behavior, the agent-based brain model comprising nodes and edges that interconnect said nodes, rules and/or model parameters that define a functional behavior of said nodes and edges, the computer program product comprising:
a computer readable storage medium having computer readable program code embodied in said medium, said computer readable program code comprising:
computer readable program code configured to observe physiological interactions of said nodes that are connected by respective ones of said edges;
computer readable program code configured to assign said nodes to respective brain regions;
computer readable program code configured to define said edges responsive to physiological interactions and/or anatomical connections; and
computer readable program code configured to define said rules and/or model parameters responsive to the observed physiological interactions and/or anatomical connections of the brain regions connected by said edges to thereby provide an agent-based brain model for predicting and/or analyzing brain behavior.
